(19) United States
(12) Patent Application Publication
(10) Pub. No.: US 2008/0228651 A1
(43) Pub. Date: Sep. 18, 2008

(54) Public Key Crytography Method and System

(76) Inventor: Zan Tapsell, Auckland (NZ)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/571,907

(22) PCT Filed: Sep. 27, 2004
(86) PCT No.: PCT/NZ2004/000235

§ 371 Date: Mar. 14, 2006

(30) Foreign Application Priority Data
Sep. 29, 2003 (NZ) 528540

(51) Int. Cl. H04L 9/00

(52) U.S. Cl. 705/65

(57) ABSTRACT

A system is disclosed relating to the use of digital certificates to improve internet communications. In one embodiment digital certificates are used to facilitate payment for goods or services, where the digital certificate is designated as having a certain value. In a further embodiment digital certificates are used for reducing or preventing unsolicited emails or spam. In a still further embodiment digital certificates are used in a digital Lottery System.

### FIELD OF INVENTION

The present invention relates to the use of public key encryption systems in commerce.

### BACKGROUND

Unsolicited email or spam is a worldwide menace that is choking email systems globally. Spam is time consuming and costly to control. Current methods that try to characterize or define what is or is not spam based on filtering techniques often suffer from false positives because deciding what is spam is such a subjective categorization process. A Method that seeks to quantitatively determine what spam is, without a subjective component, will ultimately fail. Other methods that seek to create a cost associated with sending individual email messages ultimately penalise those users who send legitimate email and for this reason such systems would have difficulty gaining widespread acceptance. Further methods such as Yahoo's DomainKeys require an overhaul of the internet and email related systems that are already in place. Other methods that seek to negate the right to anonymity for a user sending email take away a fundamental aspect of email which is being able to send anonymous email. What is needed is a system that doesn't break what is already in place, a system that doesn't create a charge per message, a system that allows anonymity and yet makes the user accountable for what email they send by non-repudiation to a certificate that signs the email.

Various electronic commerce systems using the internet exist and most if not all rely on payment using conventional means and are not simple to use. What is needed is a simple method of conducting electronic commerce including the provision of payment systems.

For example, prior art mobile payment solutions such as Vodafones' UK M-pay rely on proprietary implementations that restricts scalability globally without complex and diverse interconnection agreements and costly rollouts. Such solutions don't integrate well with online shopping and would be prohibitively expensive for a small business to take part in it. What is needed is a system that can scale well globally and doesn't rely on proprietary implementations that seek to exclude all other carriers. What is needed is a system that can also integrate well with online shopping and from a supplier stand point is attainable by everyone. From a user stand point such a system must be easy, cost effective, secure, and efficient to use.

More and more shoppers are turning to the internet to find and buy goods and services. Conventional methods of payment using credit card transactions are not suitable for micro-payment transactions. For suppliers to implement the ability to accept online credit card payments can be a complex and expensive process to set up for the supplier. Other methods such as PayPal serve as a frontend clearing house for credit card transactions therefore a user would require a credit card to use such a system. Further methods such as online Banking with bank to bank transfers don't scale well to handling geographically diverse transactions and would not handle micro payments well. What is needed is a simple method of payment that is cost effective to set up for a supplier, efficient, scalable globally over the internet, simple to use for the end user, and capable of macro and micro-payment transactions.

Conventional lotteries often rely on a piece of paper with the lottery numbers and validation printed on that paper. The lotteries are often geographically isolated which limits how big the payouts can become based on regional populations. Payouts are handled by conventional methods which hinders their scalability and integration with the internet. What is needed is a lottery system that allows anyone who can access the internet to be able to participate and participate with ease.

Methods to launch external applications from within another application over an internetworking environment rely on plug-ins and other proprietary software architectural support. Solutions such as Macromedia Flash plugin. ActiveX etc are insecure, exploitable and susceptible to foul play which in this day and age can be costly and. devastating for businesses whose systems are using such technologies. What is needed is a system that can non-repudiate what is being launched with what is launching it.

### SUMMARY OF THE INVENTION

It is an object of the present invention to provide a system of electronic commerce and spam prevention that goes some way to overcoming the abovementioned disadvantages in the prior art or which will at least provide the public with a useful choice.

Accordingly, in a first aspect the present invention consists in a system for transferring value including the steps of:

means for issuing a digital money certificate to a transferor, said digital money certificate including a unique identifier and an equivalent monetary value or a reference to, or an identifier of said monetary value;

means for receiving instructions from said transferor for a transfer of a specified value to a transferee, said instructions digitally signed by said certificate; and

means for transferring said value according to said instructions from said transferor to said transferee.

Preferably said system includes means for issuing said digital money includes:

means for receiving the public key of the transferor, means for generating said digital money certificate using said public key; and

means for sending said certificate to said transferor.

Preferably said means for issuing said digital money further includes means for placing said generated certificate on hold until confirmation of receipt of said certificate is received.

Preferably said system further comprises means for controlling access to said digital money certificates that have been issued.

Preferably said means for issuing said digital money includes means for storing said public key of said client.

Preferably said means for transferring value includes:

means for receiving the unique identifier of a receiving certificate to transfer said value to and being signed by at least one paying certificate, from which said value is transferred;

means for validating said paying certificate;

means for validating said instructions;

means for reducing the monetary amount of said at least one paying certificate by said specific value or revoking said at least one paying certificate and providing a replacement of equivalent monetary amount less said specific value; and

means for increasing the monetary amount of said receiving certificate by said specific value, for providing a further certificate of monetary amount equivalent to said specific value or revoking said receiving certificate and providing a replacement of equivalent monetary value plus said specific amount.

Preferably said means for transferring value further includes:

means for sending said replacement certificates to transferor and transferee; and

means for receiving confirmation of receipt of said changed certificates Preferably said digital certificate is an X.509 format certificate.

Preferably said digital certificate includes an electronic address of the owner of said certificate and said electronic address is stored with said information about said certificate.

Preferably said system further comprises means for consolidating the monetary value of multiple digital certificates into a single certificate.

Preferably said system further comprises means for converting digital money into other monetary forms.

Preferably said system includes a means for converting digital money certificates into other monetary forms includes:

means for receiving conversion instructions signed by said digital money certificates, means for validating said digital money certificate to be converted, and means for validating said conversion instructions.

Preferably said system further comprises means for splitting the monetary value of a single digital certificate into multiple certificates.

Preferably said receiving certificate is not usable as a paying certificate.

Preferably said receiving certificate is usable as a paying certificate.

Preferably said instructions are received by email.

Preferably said means for validating said instructions include checking the validity of said at least one signing certificate.

Preferably said means for validating said instructions further includes validating the sender electronic address of said instructions and said certificate has at least one valid instructing electronic address included in said certificate and said at least one valid instructing electronic address is stored with said information about said certificate.

Preferably said electronic addresses are email addresses.

Preferably said means for validating said instructions further include validating the sender email address domain of said instructions and said certificate has at least one valid instructing email address domain included in said certificate and said at least one valid instructing email address domain is stored with said information about said certificate.

Preferably each said at least one paying certificate is placed on hold during said transfer.

Preferably said digital monetary certificate includes the currency of said monetary value, said currency being stored with said information on said certificate.

Preferably said instructions include the currency of said transfer and said system of digital money includes means for converting one currency to another.

Preferably said instructions are generated by an email client plug-in.

In a second aspect the present invention consists in a system for transferring value including the steps of:

means for receiving from a vendor website digital payment control in relation to offered goods and services or other valuable consideration, wherein said vendor makes said payment control available on their website for a user to activate in relation to a proposed transaction;

central authority means for storing information in association with an activated control, said information including information on said vendor and details of the transaction; and

means for providing a transaction identifier and a reverse billing method to said user.

Preferably said means for providing a reverse billing method includes:

means for providing a number for reverse billing, said number depending on the amount of payment.

Preferably said billing number comprises multiple reverse sms, ems or mms billing numbers.

Preferably said multiple sms, ems or mms billing numbers are displayed to said user.

Preferably only the first of said multiple reverse sms, ems or mms billing numbers are displayed to said user and on receipt of confirmation of reverse billing using said first sms billing number an sms message is sent to said user to reply to, on receipt of confirmation of reverse billing in respect of said reply to message further messages for reply to are sent until total payment has been confirmed.

Preferably said system further comprises means for obtaining payment of said amount of payment includes means for setting the amount reverse billed.

Preferably said means for setting the amount comprises notifying the sms, ems or mms reverse billing system of the amount to bill.

Preferably said means for setting the amount comprises including the amount to be billed in sms, ems or mms message sent by said user.

Preferably said system further comprises means for receiving a control includes means for receiving instructions for payment using a system for transferring value as described above and means to enable payment and/or reimbursement to be made using said digital money certificates.

Preferably said means for receiving instructions includes means for receiving said digital money certificate serial number and an electronic address.

Preferably said systems further includes:

means for recording said transaction in association with said vendor;

means for allowing a payee to express their satisfaction or otherwise with regard to said transaction; and

means to obtain a summary of the satisfaction or otherwise of purchasers from a vendor.

In a third aspect the present invention consists in a system of preventing unsolicited emails signed by digital certificates identifying a message sender including:

means for storing information on a plurality of said identification certificates, said information including the validity of said identification certificate;

means for invalidating the identification certificate of spam message senders.

means for sending a message to at least one recipient, signed with one of said identification certificate, and

means for checking if said message is signed by a valid certificate, wherein if said message is not signed by a valid certificate it is considered to be spam; and

Preferably said system further comprises a means for receiving a list of invalid certificates.

Preferably said list of invalid certificates is updated before checking if said message is signed by a valid certificate.

Preferably said system further comprises a means for providing an identification certificate to a message sender.

Preferably said system further comprises means for automatically marking messages that do not have a valid digital signature as potential spam, and means for sorting marked messages into a spam folder.

Preferably said system further comprises means for invalidating the identification certificate of a message sender who sends spam including:

means for a recipient of a signed message the recipient considers to be spam to notify the provider of said identification certificate, said spam notification including a nested copy of the signed message that is signed by the recipient;

means for the provider of said identification certificate to store said spam notification in association with said certificate; and

means for marking as invalid said certificate when the number of spam notifications by individual message recipients exceeds a certain number.

Preferably access to said means for providing an identification certificate to a message sender is restricted.

Preferably said means for restricting is selected from a group consisting of requiring a payment, limiting access based on IP address, limiting access based on time of last access and any other means that could be used to prevent a message sender obtaining identification certificates.

Preferably said identification certificate includes an indication of the number of times the signed message can be forwarded on by the message recipient

Preferably said identification certificate includes means for the sender to indicate for each signed message the number of times the signed message can be forwarded on by the message recipient.

Preferably said means for said sender to sign at least one message with said identification certificate before sending said message to at least one recipient is a plug-in for an email client.

Preferably said means for checking said message is signed by a valid certificate is a plug-in for an email client.

Preferably said means for automatically marking messages that do not have a valid digital signature as potential spam is a plug-in for an email client Preferably said means for sorting marked messages into a spam folder is a plug-in for an email client.

Preferably said means for a recipient of a signed message the recipient considers to be spam is to notify the provider of said identification certificate, said spam notification including a nested copy of the signed message that is signed by the recipient is a plug-in for an email client.

Preferably said list of invalid certificates is updated before checking if said message is signed by a valid certificate by a plug-in for an email client.

In a fourth aspect the present invention consists in a system for running a digital lottery including:

means for issuing a digital lottery certificate, said digital lottery certificate including a unique identifier and at least one lottery entry; and

means for storing information about a said certificate and including the lottery entry details, a reference to, or an identifier of said entry details.

Preferably said means for issuing said digital lottery certificates includes:

means for receiving the public key of a purchaser;

means for receiving the lottery numbers of said purchaser;

means for generating said digital lottery certificate using said public key and said lottery numbers; and

means for sending said certificate to said client, means for associating said digital lottery certificate with a particular lottery draw.

Preferably said system includes:

means for determining which lottery certificate has won a prize; and

means for notifying said winning lottery certificate owner of a win.

Preferably said notification is conducted through email.

Preferably said system further comprises a means for receiving instructions to transfer lottery winner payment details of a winning lottery certificate include:

means for validating a winning lottery certificate;

means for validating said winning lottery certificate payment instructions;

means for paying winnings.

Preferably said payment winnings are sent using digital money certificates according to the system for transferring value as described above.

Preferably said instructions are received by email.

Preferably said means for validating said winning lottery certificate payment instructions include means for checking the validity of said signing certificate and checking the validity of signed instructions.

Preferably said digital lottery certificate is an X.509 type certificate.

Preferably said digital lottery certificate includes an electronic address of the owner of said certificate and said electronic address is stored in association with said information about said certificate.

Preferably said electronic address is an email address.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constrictions of which the following gives examples.

### BRIEF DESCRIPTION OF THE DRAWINGS

Examples of the present invention will now be described with reference to the accompanying drawings in which;

FIG. 1 is a block diagram of the system and method of the present invention,

FIG. 2 is a block diagram of an alternative embodiment of the system and method of the present invention,

FIG. 3 is an example payer payment message of an embodiment of the present invention,

FIG. 4 is an example payee payment message of an embodiment of the present invention,

FIG. 5 is an example payment verification message of an embodiment of the present invention,

FIG. 6 is an example certificate consolidation message of an embodiment of the present invention,

FIG. 7 is an example certificate consolidation verification message of an embodiment of the present invention,

FIG. 8 is an example lottery payment message of an embodiment of the present invention.

FIG. 9 is a block diagram of an alternative embodiment of the system and method of the present invention.

FIG. 10 is a block diagram of an alternative embodiment of the system and method of the present invention.

FIG. 11 is an example of the tag format of an embodiment of the present invention.

FIG. 12 is a screen for product and cellular phone details.

FIG. 13 is a screen for cellular phone and reverse billing details.

FIG. 14 is an example of a hyperlink control.

### DETAILED DESCRIPTION

While the present invention has been described with reference to X.509 type digital certificates, other types of digital certificates can also be suitable for use. The key necessity being that Public Key Cryptography be used.

### Message Filter

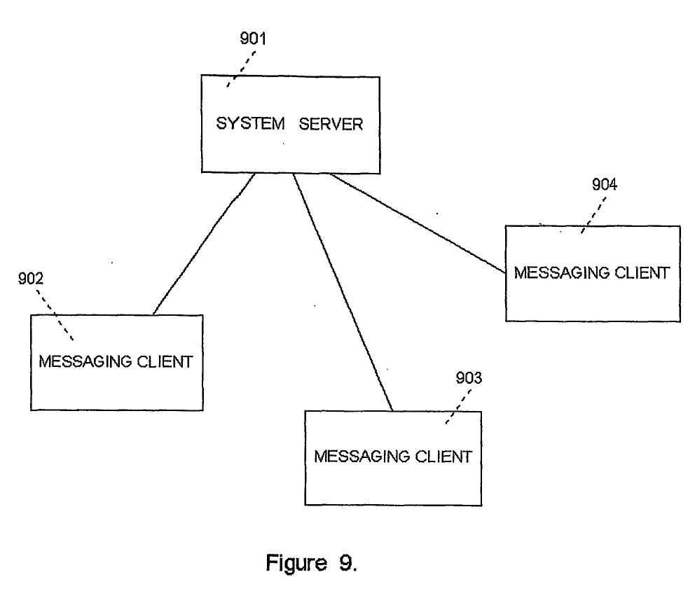

The present invention provides a method and system to control/filter unsolicited messages using public key cryptography. In the preferred embodiment a Public Key Infrastructure and corresponding Certification Authority hierarchy are set up to stop spam emails. The structure is called a Spam Fighting Certification Authority System. The Spam Fighting Certification Authority System being composed of a Public Key Infrastructure and corresponding Certification Authority Hierarchy and the necessary transactional, messaging and web services required by the Spam Fighting Certification Authority System to function. The Spam Fighting Certification Authority System is represented in the diagram of FIG. 9 as system server 901. Referring to FIG. 9 the system includes a server 901 connected to a network, typically the internet. The Spam Fighting Certification Authority provides signed messaging certificates to users, the certificates are provided to anyone who applies for them. Users can apply using a personal computer 902 or other web enabled device that can interface with a web server that is part of the system server 901. Users can apply anonymously and can use internet aliases if they desire. The purpose of the certificates is to prevent spam, not to verify a users personal identity. The preferred embodiment uses X.509 certificates that work in accordance with the PKCS #7 standard or a derivative of it as supported by PEM and S/MIME. Alternatively any type of digital certificate that can digitally sign email could be used.

As part of the certification process, users will receive a plug-in for whichever messaging client they are using. Among other things, the plug-in allows for the filtering of messages received by the user into signed and non signed categories, other categories could be used as well. The plug-in filters messages based on whether the received message is signed by a user whose certificate is signed by a Spam Fighting Certification Authority. In an alternate embodiment the functionality of the plug-in is built into the messaging client.

The signed message that the recipient has received allows the recipient to complain to the Spam Fighting Certification Authority if they consider the message that they have received to be spam.

In the preferred embodiment to lodge a complaint the received spam is signed by the recipient using their email or messaging client 902 and forwarded to an email address associated with the Spain Fighting Certification Authority System server 901. The Spam Fighting Certification Authority System 901 extracts and verifies the necessary information from the multiply signed message that it receives. Signing a message multiple times is commonly called nesting. The information extracted from the spammers signed portion of the message is the recipients email address and the serial number of the sender/spammers digital certificate as provided by the Spam Fighting Certification Authority System 901. The information extracted from the complainants digital signing of the message is the email address associated with the certificate of the complainant/recipient.

In the preferred embodiment if the complainant and recipient addresses are different the spam fighting certification authority system 901 would record both addresses but only count as one black mark against the sender/spammer. In an alternative embodiment the Spam Fighting Certification Authority System 901 would not count the complaint if the complainant and recipient addresses are different.

In the preferred embodiment the plug-in would have a button or other means to allow a user to automatically submit a spam complaint. The Spain Fighting Certification Authority System stores in a database accessible by the system server 901 all the complaints it receives. The Spam Fighting Certification Authority System 901 only registers complaints if the complaint is about a signed message that a user has received and the complaint itself is signed. This is because of the importance of being sure who sent the message and who sent the complaint digital signing, nesting and hence non-repudiation are used. The identity that the digital certificates provide are only relative to the Spam Fighting Certification Authority System in which they are used.

All that can be said about a signed message with this system is that whoever or whatever digitally signed the message has access to the private key associated with the public key that was signed into the digital certificate that was used to digitally sign the message and whoever or whatever also has access to the messaging address that was signed into the digital certificate.

While spammers can choose not to send signed messages such messages are easily filtered into the non signed message category by the plug-in. Messages signed with certificates from different Certification Authorities not associated with the Spam Fighting Certification Authority System 901 are treated as non-signed unless they are also signed by a valid certificate provided by the Spam Fighting Certification Authority System 901. Spammers can also choose to register with a bogus name etc and get a valid signed certificate for a particular email address that they will use to send out spam.

In the preferred embodiment anyone will only be able to register and obtain a certificate, but the Certification Authority System 901 will only issue a limited number of certificates per ip address for a given time period. Such a period could be bypassed upon payment of a fee. If a spammer uses a spam fighting signed message to send out spam, then the users who receive those messages can easily submit a complaint to the Spam Fighting Certification Authority System.

Once the number of complaints for a certificate reaches a certain number within a period or a maximum total number of complaints is reached the certificate of the spammer is revoked by the Spam Fighting Certification Authority System 901.

To facilitate proper filtering at the client the messaging client plug-in installed on messaging clients 902, 903, 904 will automatically download a Certificate Revocation List from the Spam Fighting Certification Authority System server 901 before sorting messages. Alternatively the messaging clients 902, 903, 904 will download the list at set time intervals. Messages signed by revoked certificates automatically go into a spam category as certified spam. Unsigned messages go into a non signed category as possible spam.

The plug-in of the preferred embodiment also provides a mechanism for users to add messaging addresses of know parties, such messages are sorted into a category of known senders. Other categories can also be defined.

The certificate that a user applies for is sent back to a specific email address. This address is signed into the certificate. The user can use a bogus name if they so choose. If a user accuses another user of sending spam then the accusing user has to stand by the accusation by having their email address made available to the user accused of spamming. A list of users who made the complaint would be made available via email but any other distribution method such as publishing on the web via system server 901 also could be used. This enables the accused user to remove the parties who complained from a distribution list and apply for another certificate.

If 50 people make a complaint in one day about a particular spammer and the spammers certificate only allows for 5 complaints per day and/or 15 in total then only the minimum number of addresses that caused the certificate to be revoked are published, in this case it would be the first 5 to make a complaint.

Legitimate spam fighting certificates would be automatically renewed at the end of a period, in the preferred embodiment every month. Renewal of the certificates helps prevent the revocation list growing too large as only certificates that have been revoked and have not expired would be in the list. The preferred embodiment would allow incremental retrieval of the Certificate Revocation List for the end user from the system 901. In addition to email messaging, this process can be applied to any digital messaging medium that can use public key cryptography and Public Key Infrastructure, for example instant messaging.

Subsequent parties who receive the spam will have it automatically filtered out based on the latest update of the certificate revocation list. The spam fighting certification authority could charge a small fee to certain classes of users but for others the service would be free.

The digital certification process will make it uneconomical for spammers to operate. If a user receives messages that are not signed by certificates certified by the Spam Fighting Certification Authority System 901 then they will still receive them, but the messages will be filtered into a non signed folder.

In the situation where user1 sends a message to user2 who forwards it to user3 who in turn forwards it to user4. Forwarding in this context means that the user signs the message with their Spam Fighting Certification Authority System signed certificate and forwards the message on. Who of user1, user2 or user3 should get a black mark, if user4 complains?

If only user3 gets a black mark then spammers could set up a grid of message relays. Messages would go into the grid, get round robined to relays and possibly bypass the number of spam per day rule. In the preferred embodiment each of user1, user2 and user3 gets a black mark.

While described with reference to a plug-in the invention will work without the use of a plug-in. The user using an email client could perform all the tasks performed by the plug-in.

In an alternative embodiment the plug-in would enforce a “no forwarding” policy or only allow forwarding a number of times. “No forwarding” would be enforced by the plug-in of the user receiving messages rather than the plug-in of the user sending messages. This could be achieved in a number of different ways i.e. a user might have say 5 certificates installed (0, 1, 2, 3 and 4). A “no forwarding” certificate would include within the certificate the number of times the message signed by the certificate can be forwarded on. If the user decides to allow a message to be forwarded only twice then the user would use number 2 certificate to sign the message. If the user doesn't want the email forwarded at all then the user would use number 0 certificate. In the preferred embodiment the plug-in facilitates the selection of a “no forwarding” certificate which is used to sign an outgoing message as well as the users' certificate used to sign the outgoing message, using nesting.

If an end user receives a forwarded message whereby a “no forwarding” certificate signed the original message as well as the users certificate being used to sign this message then the message is automatically filtered as spam by the receiving users plug-in. If only a “no forwarding” certificate is used to sign the message, the message is automatically deemed spam and filtered accordingly by the receiving users plug-in. A recipient of one of these messages cannot cause a complaint/black mark to be recorded against the user who forwarded the message or the original message composer. The message is deemed spam because it broke the forwarding policy that the “no forwarding” certificate represents. If a user who received a “no forwarding” message tried to cause a black mark to be put against the message sender the spam certification authority would reject the complaint.

In an alternative embodiment a “no forwarding” type string is added to a user's certificate. Other certificates might be available that imply “no forwarding” or “allow forwarding x times”. Using such certificates an outgoing message would only need to be signed once. In a further alternative all user signing certificates by default will not allow forwarding unless they have an “allow forwarding x times” string embedded in the certificate somewhere. The plug-in of the preferred embodiment will filter the message accordingly based on the rules defined for the allowed or disallowed forwarding of messages. In a further alternate embodiment, filtering out messages that have been certified as spam by the Spam Fighting Certification Authority System 901 would happen on the users local mail server and digital signing of outgoing messages would also happen at the users local mail server.

It can be seen that the digitally signed messaging system as used in the embodiment of this invention (particularly with respect to instant messaging) can be used to initiate other types of messaging communication such as video and voice communication over the internet such that unsolicited voice and video communication over the internet can effectively be dealt with this system in place.

### Payment Method

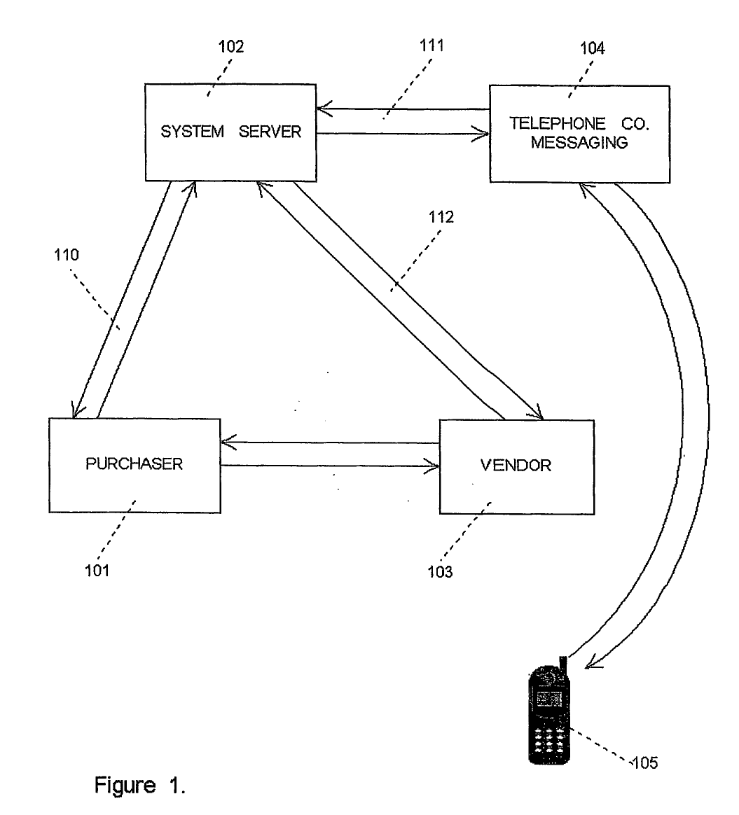

Referring to FIG. 1 the present invention provides a means to facilitate the ordering and payment for goods and services over a network via the use of digitally signed controls or non-signed controls. In the preferred embodiment a company sets up a Public Key Infrastructure and corresponding Certification Authority hierarchy to facilitate the ordering and payment for goods and services over the internet via the use of digitally signed controls or non-signed controls. The Certification Authority Hierarchy, Transaction (includes database) server, Messaging server, Web server and services supplementary to these servers are collectively referred to in the diagram of FIG. 1 as system server 102. System server 102 is connected via network 110, 111, and 112, typically the internet. The Transaction server would typically be a cluster of servers. The messaging server would typically be a cluster of servers. Likewise the Web server would typically be a cluster of servers. The Certification Authority Hierarchy is term used to describe a group of Certificate Authorities. Examples of different types of Certification Authority Hierarchies are Root Hierarchies and Cross-Certification Hierarchies. In order to use the controls of the present invention a vendor 103 applies for a digitally signed control from the Certification Authority Payment System 102. Alternatively the control need not be digitally signed. A control is an executable program, code or script that allows user input. Java applets, activeX controls, javascript, vbscript, xml, html are all examples of potential controls. A signed control is a control that has been digitally signed by a certification authority. The user input can be as simple as clicking a hyperlink. The user input can be processed on the server side.

The signed control or non-signed control provided by the Payment Certification Authority System 102 transmits a set monetary amount and other options to a transaction server when it is used by a purchaser. Based on the information that is transmitted to the transaction server 102, the transaction server knows which vendor control has transmitted the information by referencing it's database. Each control is uniquely referenced back to a particular vendor 103. A signed control can have a multitude of options that a purchaser can select, such as what country the purchaser is in, the mobile network the purchaser uses, the purchasers email address and/or the serial number of a digital certificate, how many of the item the purchaser wants, or it might just be a single selection. Likewise a control that isn't signed can have a multitude of options or it could be as simple as a single selection hyperlink. Different controls can be used in different situations. In a bricks and mortar situation an attendant could operate the control on behalf of a purchaser.

The Certification Authority System 102 signs the digitally signed controls that the vendor applies for. In an alternative embodiment the control is not digitally signed. As part of the request for the control, the vendor will include details that will be used by the Certification Authority System 102 to pay the vendor 103. It is that such information is stored in the Transaction Server database system 102 such that it can be referenced. The vendor 103 also receives an email certificate that can be used for digitally signing/encrypting emails and can be referenced to the control or a group of controls. Alternative to receiving an email certificate the vendor could receive a unique string/number that is associated with the particular vendor. This unique string would be equivalent to a shared secret between the vendor and the Certification Authority Payment system 102. Alternatively the Payment System 102 can provide a web-page whereby a transaction identifier submitted through such a web-page could be used to check the validity of a transaction. The transfer of vendor information to the Certification Authority System 102 can be carried out securely using industry standard protocols such as SSL, TLS, S/MIME, and Privacy Enhanced Mail (PEM) etc that can secure the information transfer.

The control is uniquely referenced to a particular vendor 103 and ultimately conveys a particular monetary amount. Controls can include other options and in the preferred embodiment are referenced to an appropriate email certificate of the vendor or a shared secret between the vendor and the CA Payment system. The vendor email address signed into the certificate or referenced from the vendor supplied details when the vendor applied for the control is used by the System Server 102 to send confirmation emails for transactions carried out to the vendor.

Having obtained a control the vendor then places the control on their website 103 for customers 101 to order goods or services. In the case where a control is digitally signed customers 101 know that the control is authentic and hasn't been tampered with because it is digitally signed by this Certification Authority System 102 that the customer trusts. The embodiment where a control is not digitally signed will be discussed shortly.

Vendors 103 in general do not have only one type of goods or service to be sold. So vendors 103 can apply for multiple controls for different monetary amounts and options. Each control can have different options tailored to the situation in which it will be used. Controls can have vendor 103 defined information. Vendor 103 defined information will be transmitted with the information when the purchaser 101 uses the control or is referenced from information stored in a database based on referencing an individual control. The Certification Authority designs the controls that it supplies to vendors and will typically charge only a negligible amount for each control if anything at all. The company that runs Certification Authority Payment System takes a commission on each transaction carried out using the public key infrastructure payment process.

The Certification Authority Payment System 102 does not verify any of the information that is supplied to it when the vendor is applying for a control. If the vendor supplies the wrong details such as could include bank account details, name, address, email or other options then ultimately the vendor won't be paid. A transaction references a particular usage of a particular control and a control references information belonging to the vendor.

To use the payment system of the present invention, a purchaser 101 (or a shop attendant acting on behalf of the purchaser) clicks on a particular control to buy an item/goods or service. The case where a control is digitally signed will be discussed now. In the case where a control is digitally signed if there are options to select or information to provide then the purchaser 101 would select the appropriate options and provide the appropriate information. When the purchaser 101 clicks the submit button the control initiates a transaction and the information is transmitted to the certification authority's transaction server 102 along with information identifying the particular control.

The control information may go directly to the transaction server 102; or by way of the vendor's server 103. By way of the vendors server 103, allows the vendor to know that a transaction is pending for a particular item/goods or service. In the preferred embodiment the control connects directly to the transaction server system 102. The transaction server 102 receives this information and optionally verifies that the information submitted from the control is authentic and unmodified. The control could use encryption techniques such as SSL, TLS or SGC to transfer this information. For added security a control may have a built in signing certificate that it can use to sign the information sent to the transaction server.

The transaction server 102 generates a transaction number (or string) that is uniquely referenced to the signed control, vendor, and the options transmitted from the control. This unique identification number/string is transmitted via the communications network 110 to the purchaser. In the preferred embodiment the unique identification number/string will appear within the signed control on the screen. In alternative embodiments web pop-ups, or redirection to a web page would be used.

In addition, a number that the purchaser 101 is to send a text message (or text string within a message sent with a mobile messaging service) to is also transmitted and displayed, the number is calculated based on the information the purchaser provides in the control. Examples of mobile messaging services are SMS (Short Messaging Service), EMS (Enhanced Messaging Service), and MMS (Multimedia Messaging Service). These mobile messaging services can accommodate a text message or text string within the messages that are sent using these mobile messaging services. For the sake of clarity, Text Message as referred to in this document is taken to mean the embodiment where a text string is sent in a message using a mobile messaging service, examples of which would be SMS, EMS, MMS. SSL, TLS, SGC etc could be used to facilitate the integrity of information transmitted. For example, when a purchaser 101 selects a control an SSL connection could be established to the transaction server system and purchaser information and vendor information is transferred. The information is processed and return information is sent back to the purchaser.

The case where a control is not digitally signed will now be discussed. In the case where a control is not digitally signed the vendor would place the control that they have applied for on their website. As merely an example, the control could be a web based form or for example it could be as simple as a hyperlink that the purchaser clicks. Form elements typically have an input type, name attribute, and value.

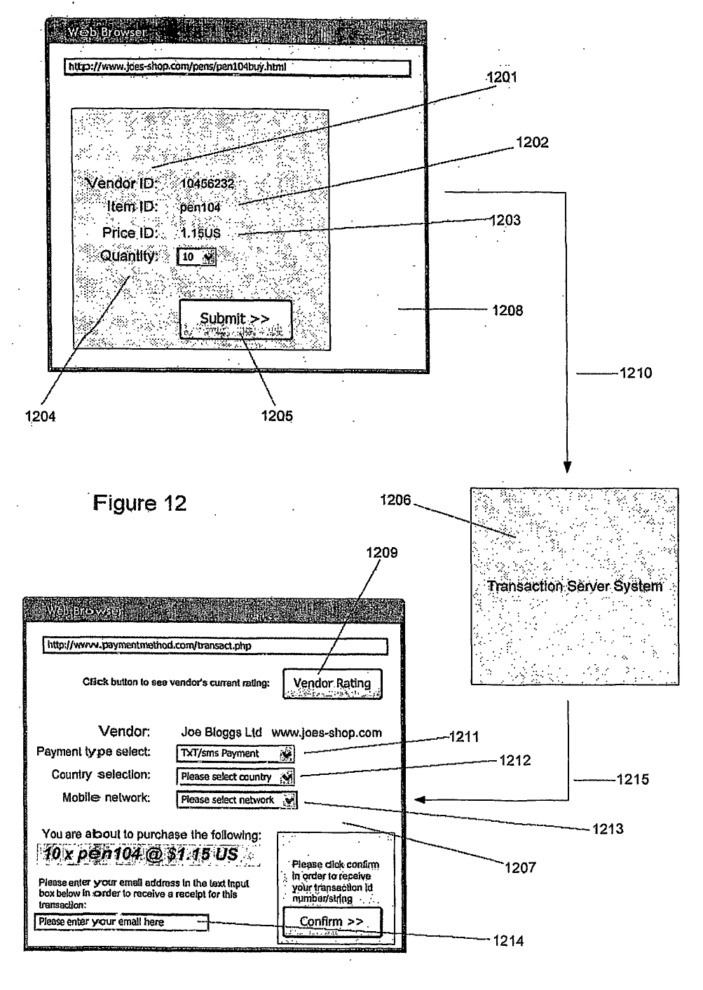

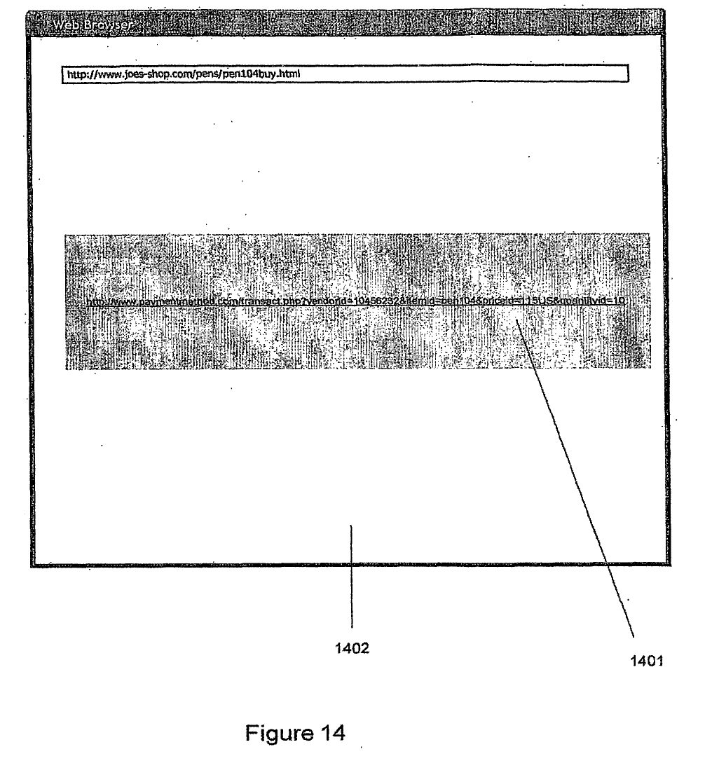

Referring to FIG. 12 we see an example of a non-signed control used in the payment process. Referring to FIG. 12 we see an example of where a control is a web based form. The control in the example has a Vendor ID 1201, Item ID 1202, Price ID 1203 and Quantity ID 1204 form elements. In the example Vendor ID 1201, Item ID 1202, Price ID 1203 and Quantity ID 1204 are the name attributes given to the form elements. Name attributes are best without spaces but for the sake of clarity the spaces will be left in. The Vendor ID 1201 is used to relate the usage of a control to a particular vendor and so the Vendor ID 1 201 field value is a unique string/number among vendors and would be assigned to the vendor and therefore the control typically when the vendor applies/registers for a control. The Item ID 1202 is used by the vendor to identify their goods or services they are selling. The string/number value that Item ID 1202 represents would typically be assigned by the vendor. Likewise for the Price ID 1203 and other options. If Quantity ID 1204 is not used in the control then by default the quantity of the goods/service to be purchased would by default be one. It is not a requirement that the Item ID 1202 be unique among vendors. The Price ID 1203 would typically convey the monetary value of what the purchaser is buying. Typically for globalised purchases the Price ID 1203 would convey the monetary value and optionally the value would be conveyed in a particular currency (eg. 115US which could be equivalent to $1.15 US dollars), although the currency type could also be referenced from vendor details stored in the Transaction Server database 1206. The currency type would only really be relevant for transactions where the currency type of the purchaser is different from that of the vendor as would be the case for global transactions. Optionally other elements of the control could be made available to the purchaser. Such elements might include but are not limited to; Quantity ID 1204, Purchaser Email, etc. An example of where a hyperlink 1401 is the control is given in the web page 1402 example of FIG. 14.

Web based forms allow greater selection options for purchasers whereas hyperlinks don't have the luxury of user selection/input options such as quantity, email address etc. Form elements such as Item ID 1202, Quantity ID 1204 etc could use different form elements such as drop down lists, radio buttons, multi line lists, input text boxes etc. A single form field could be the combination of multiple form fields. As an example only, Price ID=115US could be equivalent to dollarValue=1, centsValue=15, and currencyValue=US. Referring to FIG. 12, when a purchaser clicks the submit button 1205 for the web based form or alternatively clicks the hyperlink, the information contained in the form or hyperlink is transmitted 1210 to the Transaction Server database system 1206. The transmission of the data across the internetworking environment could optionally involve secure transmission such as SSL, TLS, SGC etc.

Referring to FIG. 12 the Transaction Server system 1206 receives the transmitted form information and using this information and referencing it's databases generates a web page to be sent 1215 back to the purchaser. This sort of processing where a web page is dynamically generated is common with programming languages such as PHP, ASP etc that can integrate with a database system. As shown in FIG. 12 an example web page 1207 that could be presented to the purchaser is shown. We see that the purchaser is not on the vendors web page 1208 anymore (although frames may be used) but is instead on a web page that is associated with the Certification Authority Payment systems domain. In the example the webpage 1207 conveys to the purchaser what they are about to purchase, from whom they will purchase, and how they want to purchase as well as other things such as a vendor rating button/link 1209. The information related to what they are about to purchase is taken from the submitted form data; Item ID 1202, Price ID 1203, Quantity ID 1204. The information related to from whom they will purchase is also referenced from the submitted form data; Vendor ID 1201 and can be further referenced from vendor specific information stored in the Transaction Server Systems database 1206.

As shown in FIG. 12 which is merely an example of a web page that could be presented to the purchaser, the web page 1207 includes a web based form. The Payment Type select 1211 form element would allow the user to select the type of payment option they want to use. In this example the form element happens to be a drop down list. Examples of the type of payment options that might be available to the purchaser are Txt/sms payment, digital money payment etc which are discussed shortly. A Txt/sms payment refers to using a mobile messaging service such as SMS, EMS, MMS etc such that a text string is conveyed within the message that is sent using such a mobile messaging service and sending said message invokes a reverse billing transaction to the mobile phone/account that sent said message. Elements such as the Country Selection 1212 form element would allow the user to select what country they are in. There are other methods available such as identifying a web browsers regional settings that could automatically decide the country a purchaser is in. It is however preferable that the purchaser specifically select what country they are in such as through the use of a form element. The Country Selection 1212 element is not a necessity but it is preferable because it can serve two purposes. Firstly it can narrow the selection options for other form elements and secondly, monetary conversions between a vendor's preferred currency and a purchasers preferred currency can be done automatically by the Transaction Server System 1206. The Mobile Network 1213 selection element would be used to select the mobile phone network that the purchaser uses. It is that if the Country Selection 1212 element is used then the Mobile Selection 1213 element can present the purchaser with selection options specific to the purchaser's country. The mobile networks are typically related to the country the purchaser is in. Of course the mobile phone network selection would only really be used if the purchaser has decided to conduct a Txt/sms payment. As an example, if the purchaser selects digital money as the Payment Type Select 1211, then other form options or elements could become available for the purchaser. Of note is that if the purchaser is making a Txt/sms payment then it would not be necessary for the purchaser to select their mobile network if the Payment System has got the same reverse billing number for a particular monetary value for different mobile networks within a region (eg country) or globally. It is however preferable in the case of Txt/sms payments that the purchaser select their mobile network they use.

As shown in the example of FIG. 12 the web page 1207 also conveys to the purchaser exactly what they are about to purchase and from whom they will purchase. In the example they are buying 10×pen104@ $1.15 US ea from Joe Bloggs Ltd. We can see that this information is ultimately referenced from the information supplied from the web form of the vendor's web page 1208.

Referring to FIG. 12 as shown in the example there is a text input box 1214 available whereby the purchaser would input typically their email address or other messaging address. The email address input here serves two purposes. Firstly, a receipt for the transaction can be despatched from the Transaction Server System 1206 to the purchaser to this email address. Secondly the address is passed on to the vendor along with other transaction details so the vendor has a contact reference to the purchaser for this transaction.

Referring to FIG. 12 the vendor rating button/link 1209 would link to a vendor rating stats web page that basically gauges the trustworthiness of a vendor. Every transaction that is carried out is given a receipt for the purchaser if the purchaser supplies their email address. The receipt is in the form of an email message. It is that other messaging solutions such as for example, instant messaging could replace email messaging and obviously in the case of where instant messaging is used the purchaser would enter their instant messaging address into the text input box 1214 to receive an instant message receipt. Email is preferable though. The receipt allows the purchaser to place feedback on the vendor. As an example only, such feedback could be as simple as a good or bad rating, meaning that a good/positive feedback is where the purchaser got what they paid for and a bad/negative feedback means that the purchaser did not receive or are not satisfied with what they paid for. Typically purchasers would only really bother to place negative feedback and so the feedback would typically gauge the number/percentage of bad transactions the vendor has conducted out of how many transactions the vendor has done in total. Potential purchasers would be able to view the vendor stats page and gauge how trustworthy a vendor is. The vendor rating button/link is not a necessity but it is preferable to provide a way whereby potential purchasers can gauge the trustworthiness of a vendor based on the transactions carried out with this Payment System.

Of note is that the payment type select 1211 element is dependant on what payment options the Payment System is willing to accept. Also, information such as the purchaser email address supplied in the text input box 1214 could be supplied in the web form of web page 1208 instead of the web page 1207, or it could even be supplied in both or none. Likewise Quantity ID 1204 could be chosen/supplied in webpage 1207 instead of webpage 1208 or both or none. Payment type select 1211 could be chosen/supplied in the web form of web page 1208 instead of the web page 1207, or it could even be supplied in both. Obviously if there is only one payment type available then the payment type would not need to be selected by the purchaser.

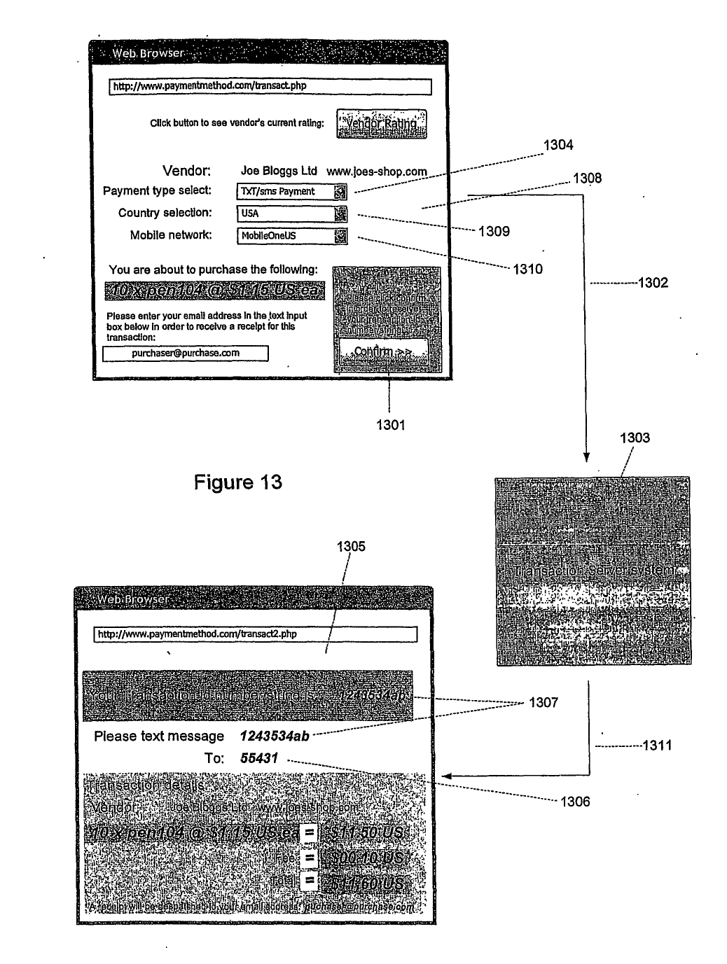

Referring to FIG. 13 once the purchaser is happy with what they have selected and what information is displayed to them, they can click the confirm button/link 1301 and the information in the form is transmitted 1302 to the transaction Server system 1303. Once again, based on the information that the Transaction Server system 1303 receives from the form, the Transaction Server system 1303 will reference it's database and use the from information to work out a text messaging number that a purchaser will be required to send a text message. Obviously the Transaction Server system 1303 would work out a text messaging number if the payment type select 1304 value in the received form information was TxT/sms payment. Different results would be calculated based on different purchaser selection/input.

Referring to FIG. 13 along with the text message number 1306, the Transaction Server system 1303 also generates a unique id number/string 1307 for this particular transaction. As shown in the example of FIG. 13 the text message number 1306 and the unique id number/string 1307 for the transaction is sent 1311 to the purchaser. The information is presented to the purchaser in a web page 1305. Obviously a succession of web pages could be used to convey this information to the purchaser.

Referring to FIG. 13 and FIG. 14 a succession of web pages and web forms could be used to collect the information necessary by the Transaction Server system 1206, 1303 to display the correct text messaging number and other information to the purchaser. A single webpage, namely the vendors, could be used to collect and supply the necessary information required by the Transaction Server System to be able to calculate the TxT/sms number or other payment option for the purchaser. It is however preferable that web based form information be gathered on at least two separate web pages. The first being the vendor's webpage 1208 and the second being the Transaction Server System's dynamically generated webpage 1207, 1308. It is also that the use of encryption techniques such as SSL, TLS etc could be used with the transmissions.

Referring to FIG. 13 when the Transaction Server System 1303 calculates the text message number to display to the purchaser, the Transaction Server System 1303 may include a fee to be charged to the purchaser. For example, if the purchaser were buying goods/service that cost 50 cents US and the fee to the purchaser for the transaction is 10 cents then the reverse billing number that is calculated would be a number that reverse bills in the amount of 60 cents US (eg cost of goods/service+fee) or equivalent in a foreign currency as could be determined by utilising the country select 1309 or mobile network 1310 and foreign exchange rates. Alternatively, the TS system may instead collect a fee from the vendor instead of the purchaser, or may in fact collect a fee from both the purchaser and vendor.

Whether a signed or non-signed control is used, in the case of text message payment, the phone number that the purchaser sends a text message would allow a reverse billing operation to the purchaser's mobile phone/account of the monetary amount of the purchase obviously subject to possible transaction fees. The Certification Authority Payment System 102 would use multiple text message numbers (in multiple countries) in different monetary amounts that carry out reverse billing in that amount for a particular mobile network. For example, if the payment total for a purchaser was $11.60 US, and the purchaser's mobile network was say MobileOneUS then the Payment System 102 would reference the reverse billing number that is stored in it's database that would reverse bill in the amount of $11.60 US for MobileOneUS customers. In the text message the purchaser 101 includes the identification number/string that represents the particular transaction as generated by the transaction server. In the case of larger payments a caterpillar payment process discussed shortly could be used. As discussed earlier it would be irrelevant what mobile network the purchaser uses if the Payment System could get the same reverse billing number across different mobile networks that reverse bill in the same monetary amount within a region (eg country).

Once the messaging gateway 104 receives the id number/string it will reverse bill the cost of the message as deemed by the messaging gateway number to the mobile phone/account 105 that sent the message. If successful the messaging gateway 104 also sends a digitally signed message to the transaction server 102 to let the transaction server 102 know that it has received the text message containing the identification number/string from the purchaser and it has billed the purchaser accordingly. The identification number/string is contained in this message that the messaging gateway sends. The messaging gateway 104 has to transfer the transact id number/string to the transaction server 102 with non repudiation and integrity. In the preferred embodiment a digitally signed message is sent such as a digitally signed email message. Any other method with which non repudiation and integrity can be achieved is also suitable. The value that has been reverse billed could also be included in the message, also if separate signing certificates are associated for each reverse billing number then the certificate can be referenced back to a reverse billing value for confirmation that the correct value was reverse billed with the correct transaction id number/string.

Once the transaction server 102 has received the confirmation from the text message gateway 104 and verified it is authentic and unmodified it will then process the identification number/string and reference it back to its stored transaction identification number/string and associated details. The transaction server 102 will send a confirmation digital message to the vendor 103 to let the vendor 103 know that payment has been made by a purchaser 101. This message is digitally signed so the vendor 103 knows that it is authentic and unmodified (encrypted if need be). Alternatively to digitally signing this message the transaction server 102 would include the shared secret between it and the particular vendor the message is destined for. Alternatively the confirmation message need not be digitally signed and need not include the shared secret. The confirmation message contains the identification number/string and optionally other information such as vendor defined information, payment amount and other relevant purchaser 101 information that the vendor 103 might need.

The vendor 103 replies to the message via email using the email certificate they obtained with the control to digitally sign the message or alternatively by replying to the message that optionally includes the shared secret being in the message but is not digitally signed. This confirmation reply message to the transaction server 102 lets the transaction server 102 know that the vendor 103 has received the confirmation message and understand that the customer has paid for the goods/service and that they the vendor 103 have received the details relevant to the transaction.

Once the vendor 103 has received the confirmation message they can supply the goods/service to the customer 101. The transaction server 102 keeps a track of all the transaction payments that belong to that particular vendor 103 and the System 102 pays the vendor 103 accordingly. If the transaction server 102 fails to receive a digitally signed receipt from the vendor 103 or alternatively fails to receive a non-signed receipt message that optionally includes the shared secret for the transaction within a time period, the transaction server 102 will resend the confirmation message over a period of time up to a certain number of times. Then, if the transaction server 102 still hasn't received a reply from the vendor it will void the transaction for the vendor 103. This means that the vendor 103 is not paid for this particular transaction.

In the preferred embodiment the System 102 will reimburse the purchase using digital money minus a transaction failure fee but other forms of reimbursement can be used or alternatively no reimbursement will be made. The system 102 is only able to reimburse the purchaser 101 using digital money if the purchaser 101 has provided their digital money serial number. In an alternative embodiment, the certification authority system 102 could credit the mobile phone/account of the purchaser 105.

This process is very convenient as among other things it allows a user to only carry their mobile telephone 105 or pocket pc/pda with them and know that they can buy goods or services whether it be in a shop or at home across the internet. It is also very convenient for the vendors 103. The process can be applied to any kind of commerce such as vending machines, parking meters, shops, on the spot billing for contractors or internet shopping.

In an alternative embodiment the vendor 103 receiving and responding to the confirmation message could be automated so that in the case of a shop assistant operating the control, the shop assistant would see only that the transaction has been successful. In this case a messaging user agent that the vendor 103 uses automatically receives the confirmation message and responds to it appropriately and notifies the vendor/shop assistant appropriately.

In the preferred embodiment when the transaction has been confirmed by the transaction server 102, the transaction server 102 sends a digital receipt for the transaction to the purchaser 101. The receipt could be in the form of a digitally signed email that the purchaser 101 can use as a receipt for their purchase but the email message doesn't necessarily have to be signed. This message allows the purchaser 101 to submit a complaint if they don't receive the goods that they have paid for by replying to it or forwarding it to a complaint address or using the information in the receipt in a transaction server 102 supplied web page to initiate a complaint or feedback.

The receipt includes information such that the purchaser replies or responds to the information to initiate a complaint for a particular transaction id, the said id referencing to a particular vendor.

In an alternate embodiment the complaint could also be signed by the purchaser 101 when they send it. In the case where the purchaser uses digital money to pay for the purchase they could for instance use their digital money certificate to sign it. In this case they would need to have supplied either their email address and/or digital money serial number when completing the control. The certification authority system 102 will reference against this information to double check the complaint is legitimate.

In an alternative embodiment a control would allow potential customers 101 to check whether a supplier 103 is reliable. The certification authority system 102 stores in a database attached to the system 102 all the transactions conducted with a vendor 103 over a time period. A link in the signed control allows a potential purchaser to access a report web page that reports on among other things, the good/bad transactions of the vendor 103 of the control. Likewise as explained previously, a purchaser using a non-signed control could also have access to the vendor rating stats/report webpage or webpages.

The process could also be extended to landline phones and digital messaging communications such as email communication. In the case of normal landline phones the purchaser 101 would ring up a reverse billing landline number instead of a text messaging a number and use a touch tone phone to enter the transaction id number, or by using voice recognition. For email reverse billing, the purchaser 101 would purchase a digitally signed email certificate from the certification authority 102 that is deemed to be worth a set monetary amount that the purchaser pays for. Payment using digital money is discussed in more detail below.

A caterpillar process for billing larger amounts could be used. If a purchaser 101 buys something worth say $24.50 then that amount could be broken down into say $20, $4, and 0.50 cents. The control that the purchaser 101 clicks initiates a caterpillar process where the purchaser carries out the transaction for $20 and after this is complete the next transaction ($4) is automatically sent to the purchasers mobile 105 so all the purchaser 101 has to do is to reply to it and then the next amount of 50 cents will be automatically sent to the purchasers mobile. Once all three transactions are accounted for, the confirmation is sent accordingly.

Using the above example, in an alternative form of the caterpillar process the purchaser 101 would be sent back three numbers from the initial usage of the control to text message the transaction id number to. One number would reverse bill in the amount of $20. Another would reverse bill in the amount of $4 and the third number would reverse bill in the amount of $0.50. Once all three messaging gateway numbers have sent their verifying messages to the transaction server 102, the transaction server 102 sends the confirmation message to the vendor 103. The above example could have just as well have used two numbers (eg $20 and $4.50) or 4 or more numbers.

In an alternative embodiment a single text messaging gateway number could be used, eliminating the need for the caterpillar process/multi number process for large payments. The certification authority transaction server 102 would send the transaction identification/string, amount to be reverse billed and possibly also the number to expect the text message on to the text messaging number providers management system 104 and get a signed receipt for this information from the management system 104 before notifying the purchaser 101 with the payment details to use. The information would be transferred and received using methods that ensure non repudiation, integrity and security of this transferred information. The transaction server 102 would allocate by round robin from the pool of numbers available to be called. The management system 104 uses this information to reverse bill for the particular amount based on the transaction id/number received on a messaging gateway number.

In an alternative embodiment the actual transaction identification number/string could convey both the identification number of the transaction and the amount to be paid. The messaging gateway 104 number would know based on preconfigured rules how to interpret and process the transaction string received from the purchaser to reconfigure the gateway number dynamically and then reverse bill the purchaser with the reconfigured amount. In this embodiment the purchaser 101 sends a string, for example 2450123456789 to a particular number. For example only, the gateway 104 number strips off the last 9 numbers and uses the preceding numbers to reverse bill the customer that amount. Using 2450123456789 stripping off the last 9 numbers gives 2450 or $24.50. The last nine numbers give uniqueness to the whole string.

If the purchaser 101 uses ‘digital money’ to pay for the goods/service, they select control options accordingly and the information sent back by the transaction server 102 includes a transaction identification number and an email address to send the identification number to.

The purchaser 101 then sends a message containing their transaction id number and digitally signs this message with their digital money certificate. The message is sent to the appropriate email address. Once this message is received, it is processed. The Certification Authority System 102 then checks integrity and formatting, and puts the certificate used for signing on hold.

The Certification Authority System 102 references the message to the transaction identification number that is specified and sends a digitally signed confirmation message to the vendor that contains all the relevant information that the vendor 101 needs. Upon signed receipt of a message from the vendor 101 the Certification Authority 102 generates a new digital money certificate for the purchaser 101 using the same details in the certificate but reducing the worth of the certificate and sends it back to the purchasers email address.

The message containing the new certificate can be encrypted by using the public key of the old certificate which is also the public key used in the new certificate. Only the purchaser has the corresponding private key.

The purchaser or purchasers messaging client 101 sends a digitally signed receipt for this message back to the Certification Authority System 102 and then the Certification Authority System 102 activates the digital money certificate removing the hold. The purchaser will also receive a digitally signed receipt for the completed transaction so that they can complain if they don't get the goods/service that they have paid for. Alternatively the receipt need not be digitally signed. The system 102 pays the vendor 103 accordingly.

### Digital Money

Digital money of the present invention works in a similar manner to bank cheques. A person or organization purchases a digital certificate for a particular amount from a certification authority. The digital money certificates used with email messaging work in accordance with the PKCS #7 standard or a derivative of it as supported by PEM and S/MIME. The standard supports both encryption and digital signatures. The digital certificate is deemed to be worth a monetary amount by the company that sets up the Public Key Infrastructure and corresponding Certification Authority Hierarchy, that is the Digital Money Bank. There is no need for the end user to give over any of their personal details when they purchase a digital money certificate because the Certification Authority that signs the certificate does not have to verify any of the end user details like a typical Certification Authority would. The only information that they are required to supply is their email address or messaging address and the public key of a public/private key pair that they have generated. This information will be signed into the digital money certificate along with the worth of the certificate and the certificate will be sent to the email address/messaging address that is signed into the certificate.

The purchaser of the digital certificate gives the certificate value or part value thereof to another party using the certification authority as a digital bank. In the preferred embodiment the certification authority system would design and distribute a messaging client or plug-in that would facilitate the transfer, both the sender and receiver in the preferred embodiment would use the plug-in although it is not mandatory for them to use it.

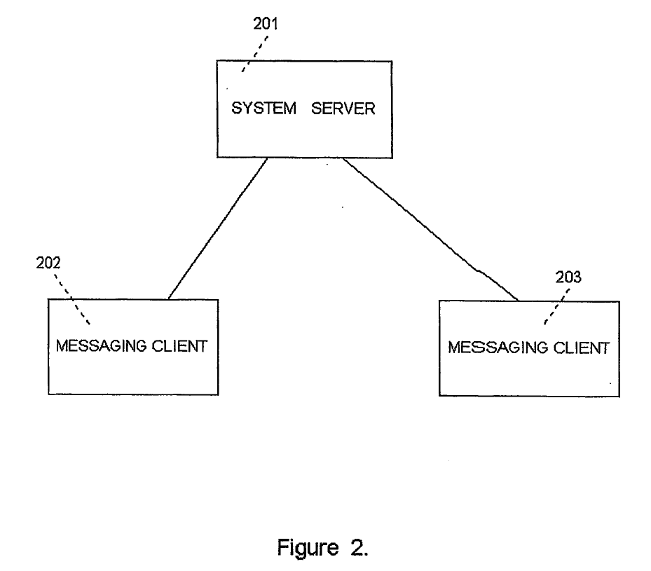

Referring to FIG. 2 A digital money transaction involves 3 parties, the company that sets up the Public Key Infrastructure and corresponding Certification Authority Hierarchy, that is the Digital Money Bank 201; the party making a payment 202 and the party receiving the payment 203.

Communication via email facilitates the digital money transaction, other digital messaging formats such as instant messaging could also be used but email is used in the preferred embodiment. In order to use other digital messaging mediums those mediums need to support Public Key Infrastructure and digital certificates.

In the preferred embodiment the company sets up the Public Key Infrastructure and corresponding Certification Authority Hierarchy for the purposes of issuing, revoking, and putting on hold digital money certificates and processing digital money transactions. This Certification Authority Hierarchy and transactional, messaging, and web services is called the Payment Certification Authority. Referring to the diagram of FIG. 2 the Payment Certification Authority is represented as system server 201. Only the Payment Certification Authority has access to the complete list of digital certificates issued or revoked.

A digital money certificate is a X.509 style digital certificate that the Payment Certification Authority System has issued and has deemed to be worth a particular monetary amount. A digital money certificate in its most basic form, allows for digital signing of email messages.

In the preferred embodiment an X.509 type digital certificate can be deemed to be worth a monetary amount and can be used as digital money by embedding one or more strings within the certificate. The embedded strings are conformant to the types of strings allowed for the particular fields within the certificate. Examples of some types of strings are PrintableString, TeletexString, BMPString, UTF8String, UniversalString, IA5String. In the preferred embodiment a string is placed in the ‘subject name’ field to convey, either directly or indirectly, the monetary worth of the certificate e.g. “subject name”=“TenDollarsUS Nontransferrable”. In an alternate embodiment, other fields such as extended non-critical fields could also be used to convey this information. The certificate is only worth the monetary amount to the Digital Money Bank that issues the certificates and the end users who trust this Digital Money Bank for carrying out digital money transactions.

In a digital money transaction the payer is a person or an application that uses a digital money certificate to pay another party. To obtain a digital money certificate the Payer 202 generates a public/private key pair and sends the public key to the Payment Certification Authority System 201 to be signed into an appropriately valued certificate that the payer has purchased. The email address of the Payer is signed into the certificate. The Payment Certification Authority System 201 sends back the signed digital money certificate to the payer 202. The payer 202 can use this digital money certificate to either send or receive payments through email.

In digital money transactions the payee is a person or application who uses digital money certificates to accept payment from others, referred to here as the payer. The payee digital money certificate is the same type as the payer digital money certificate.

In an alternative embodiment the payee 203 would be able to obtain a digital money certificate without cost. Such a certificate would have no monetary value until payments had been added to the certificate. In a further alternative, payee certificates would only be able to receive payments; such a certificate is referred to as a static certificate. A static certificate is a digital money certificate that is not revoked after a digital money transaction is carried out using it.

When a payer 202 wishes to pay using digital money, they first obtain the serial number of the payee's certificate 203. The payer 202 will also optionally obtain the email address of the payee 203 as associated with the payee's certificate. The payer 202 can obtain the serial number by any means whatsoever including telephone, web, email, or face to face contact. The serial number is important because it is guaranteed to be unique as compared with all the other digital money certificates. In an alternate embodiment some other unique string that has been written into the digital certificate can be used to uniquely identify the digital certificate.

To make the payment the payer 202 opens up their email client and composes a message to be sent to an email address of the payment certification authority system 201 e.g. payplease@paymentca.com. The message conveys the payment instructions of the payer subject to the required formatting rules of the payment certification authority system 201.

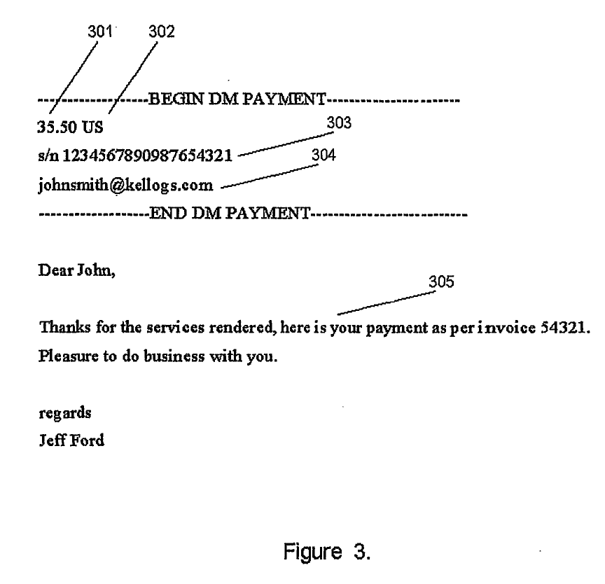

Within the body of the message the payer 202 will place formatted/delimited text to indicate that the payer 202 wants to pay someone. The email message will also include the amount the payer 202 wants to pay and the currency of payment e.g. $US35.50, the serial number of the payee's digital money certificate that the payment is to be made to. In an alternative embodiment the email address of the payee associated with the payee's digital money certificate will also be included. In a further embodiment an identifier that identifies the payee's certificate uniquely would also be included. Such an identifier would be written into a digital money certificate, an example is a string. In a further alternate embodiment, information that uniquely identifies the transaction between the payer 202 and payee 203 can be added within the delimited text although this info can be included outside of the delimited text as well, as is shown in the example of FIG. 3. This applies to all types of digital money transactions.

Referring to FIG. 3 the body of the message is illustrated including the payment amount 301, currency 302, the serial number of the payees certificate 303 and the email address of the payee 304. The email also containing a message 305. Many different formatting structures could be used to convey the necessary information required by the Payment Certification Authority System 201 to process the transaction. Before the message is sent the payer 202 signs the message with their digital money certificate that that is being used to pay the payee. Multiple certificates could be used and the certificate used to make the payment need not be in the same currency as the currency of the payment. If extra security is needed the payer 202 would encrypt the message using the public key of the Payment Certification Authority 201.

When the Payment Certification Authority System 201 receives the digitally signed message from the payer 202, the Payment Certification Authority 201 verifies the signature and that the content of the message is not changed.

If the signature or signed content is invalid the transaction is rejected straight away and the Payment Certification Authority System 201 sends a rejection reply to the payer 202. Further if the formatting of the delimited text is wrong or the amount to be paid plus the transaction fee is greater than the worth of the payer certificate, the transaction is rejected.

In an alternate embodiment if the optional email address 304 included in the delimited text does not correspond to the email address that the payment certification authority signed into the payee's certificate that has been referenced then the transaction is rejected. In this case the payee 203 email address is used as a double check to ensure payment is made to the correct party.

It is important that the Payment Certification Authority references certificate information from the complete list of stored certificates that the Payment Certification Authority holds from the unique identifier (i.e. serial number) that is provided to it by a user of the Payment Certification Authority system. Likewise, the digital certificates that end users use to sign instructions for transactions can be checked against this complete list of trusted certificates that the Payment Certification Authority holds. Although the Payment Certification Authority system would work fine without making this check a greater level of security is afforded to the system by referencing from the complete list of stored certificates that only the Payment Certification Authority has access to. This check introduces an increased latency into the transaction, but it also increases the security of the system as a whole. In an alternate embodiment the certificate check against a trusted store of digital certificates is not carried out and therefore the security of the system as a whole is reliant on the strength of the Public Key Cryptography that is used.

Once all the necessary checks are passed the Payment Certification Authority System 201 will extract the relevant payment details from the delimiting text. The digital money certificate used to sign the payer's 202 instructions is put on hold. While the certificate is on hold, any subsequent payments initiated by the payer 202 using this same certificate are rejected.

The Payment Certification Authority System 201 using the unique serial number included in the formatted/delimited text references the public key of the payee from the complete list of certificates that the Payment Certification Authority System 201 holds. The Payment Certification Authority System 201 will then generate a digital money certificate using the email address and public key of the payee's 203 digital money certificate. The Payment Certification Authority System 201 then calculates the correct value of the new certificate to be worth taking into effect any currency conversions, the existing balance and fees to be charged by the authority.

The Payment Certification Authority System 201 will also generate a new digital money certificate to be sent back to the payer 202. The Payment Certification Authority System 201 using the public key and email address of the payer's 202 digital money certificate generates a new digital certificate. The value of the new digital money certificate is the initial payer's 202 digital money value less the payment amount less a transaction fee. The new certificate is kept on hold.

To communicate the payment to the payee 203 the Payment Certification Authority System takes the “Dear John, blah blah blah . . . . ” text 305 and adds it to an email message to be sent to the payee's 203 email address. In an alternative embodiment the Payment Certification Authority System 201 would generate and add it's own message instead of or in addition to the payer's message. The Payment Certification Authority System 201 then using the public key of the payee 203 can encrypt the message to the payee 203 as an extra security measure if need be. If for example, a malicious third party were to intercept an unencrypted message, they would be able to view the contents of the message but they would not be able to act on any of this information without the private key, and only the user that the message is sent to has the corresponding private key.

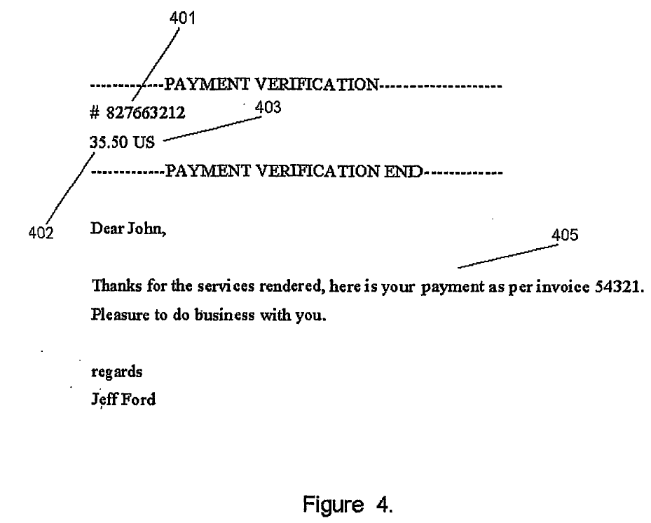

The sent message contains the newly generated payment certificate for the payee 203. Preferably the message is signed by the Payment Certification Authority System 201 as well but it is not a necessity that the message be signed. The message is sent to the payee's 203 email address associated with the payee's certificate. The message conveys that a payment is being made to them. Referring to FIG. 4 an example of the formatted/delimited text of the message from the Certification Authority System is illustrated. The subject heading might be “payment #827663212” where #827663212 is a payment number/string that the Payment Certification Authority System uses to identify the payment transaction. The payment transaction identifier could of course be delimited in the body of the message. The message could include the payment reference 401, amount 402, currency of payment 403 and the message 405.

When the payee 203 receives the message they decrypt the message if necessary and verify the authenticity of the digital signing. In the preferred embodiment the digital money certificate is installed to the payee's 203 certificate store. In an alternative embodiment the payee could store the digital certificate in any location.

Once the certificate is received the payee 203 sends a reply to the Payment Certification Authority System 201. The reply must contain the identifying transaction 401 number either formatted/delimited in the body or included in the subject. This reply needs to be signed with either the old payee certificate or the new payee certificate and is sent to the Payment Certification Authority System 201.

When the Payment Certification Authority System 201 receives the reply and has verified the signature and content if any, the Payment Certification Authority System 201 references the transaction number and checks it was expecting a reply signed using the appropriate payee certificate. When the Payment Certification Authority System 201 is satisfied with the reply it activates the new certificate that it sent to the payee 203.

In order to conclude the payer side of the transaction the same basic email transaction that happened between the payee 203 and the Payment Certification Authority System 201 now happens between the Payment Certification Authority System 201 and the payer 202.

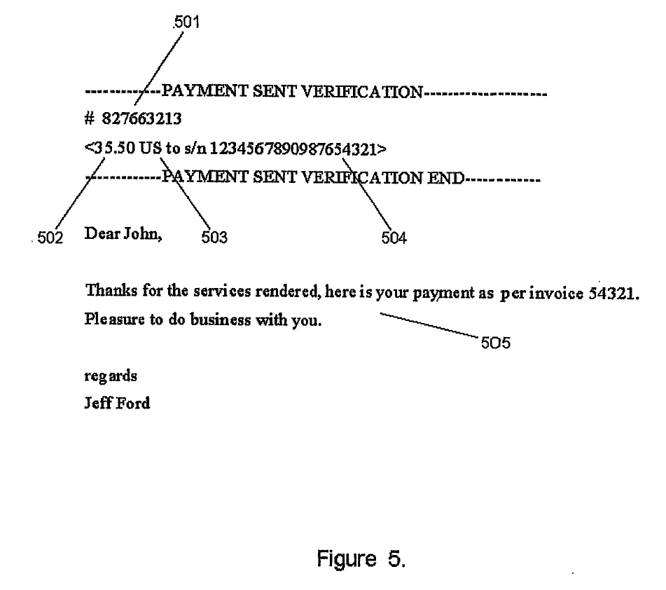

The Payment Certification Authority System 201 reply's to the original payment message or generates a new message to be sent back to the payer 202. The message conveys reference to the payer's 202 payment instructions. An example of the formatted/delimited text of the message is shown in FIG. 5. The message that the Payment Certification Authority System 201 sends contains a transaction number 501 for this part of the transaction. The message contains the amount paid 502, the currency of payment 503 and the serial number of the certificate paid 504. Optional information such as the messaging address (i.e. email address) of the digital certificate that the payment was made to could also be included. The original message 505 to be sent to the payee 203 can also be included for reference. This message also contains the newly generated digital money certificate for the payer 202. The message is preferably signed by the Payment Certification Authority System 201 and can be encrypted using the public key of the payer's certificate for extra security if need be. The payer 202 receives the message and the new certificate is installed into their certificate store. The payer 202 sends a confirmation reply to the Payment Certification Authority System 201. The reply preferably contains the identifying transaction number either delimited in the body or included in the subject. This reply is preferably signed with either the old payer certificate or the new payer certificate and sent back to the Payment Certification Authority System 201. The old certificate and the new certificate use the same public/private key pair.

The Payment Certification Authority System 201 receives the confirmation reply and verifies the signature and content if any. The payment certification authority system 201 references the transaction number and makes sure it was expecting a reply using the appropriate payer certificate for signing of this reply.

Once the Payment Certification Authority System 201 is satisfied with the reply it activates the new certificate that it sent to the payer 202, and it revokes the old certificate of the payer 202. In an alternative embodiment the payer's 202 old certificate is revoked after the payee 203 has sent their confirmation reply. At no stage during the whole transaction did we put the payee's 203 receive only certificate on hold. This is an important because it allows multiple payer's 202 to pay the same payee 203 (serial number) at the same time.

The payer 202 will remove or backup their old digital money certificate from their certificate store because it's not needed anymore.

In the event that the Payment Certification Authority System 201 does not receive the confirmation reply from the payer 201 it would send another message after an elapsed time period. After a further time period has elapsed and the Payment Certification Authority System 201 has received no reply then the new certificate is revoked.

If the transaction happens smoothly the payer 202 ends up with a digital money certificate in the amount of the original digital money value less the payment amount and the transaction fee. The payee 203 ends up with a new certificate in the amount of the payment. The transaction is now concluded.

If a payee 203 uses a payment digital money certificate to receive a payment on, the certificate is put on hold after the Payment Certification Authority System 201 processes the initial payment message and the original digital money certificate is revoked after the Payment Certification Authority System 201 receives a confirmation reply from the payee 203. The downside of receiving payments on a non-receive only certificate in this way is that only one transaction can be carried out using this certificate at a time. The benefit is that the end user will only end up with only one digital money certificate after the transaction is complete.

In an alternative embodiment all receive payments (whether they use a receive only certificate or a non-receive only certificate) are treated the same as the receive only certificate case. In this situation the receiver would end up with multiple certificates, their original certificate plus payment certificates.

If transactions are carried out in this way, a payee 203 could end up with hundreds of individual digital money certificates worth different monetary amounts and possibly also in different currencies. For better end user manageability the end user is able to consolidate multiple digital money certificates into one digital money certificate.

### Consolidation

Consolidation is basically the same process that a payer 202 would use to pay someone else; except that they are the payer 202 and the payee 203. The main difference is that the payment message formatting is slightly different and that the payment message is signed multiple times with the digital money certificates to be consolidated.

If a payer 202 wants to consolidate digital money certificates, they will first obtain the serial number of the certificate that they want to consolidate to. This could be a receive only certificate or a non-receive only certificate. Optionally the payer 202 can include the email address associated with the certificate.

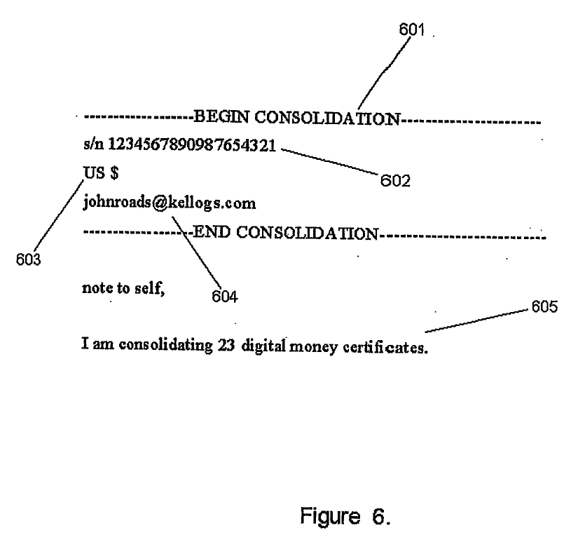

The payer 202 using an email client will compose a message to be sent to a Payment Certification Authority System's 201 email. An example of the delimited text included in the body of the message can be seen in FIG. 6. Within the body of the message the payer will place specially formatted/delimited text to indicate:
1) the payer wants to consolidate digital money certificates 601;
2) the serial number of the payee's digital money certificate that will be used to accept payment/consolidation 602;
3) optionally the type of currency to consolidate to 603;
4) optionally, the email address of the payee as associated with the payee's digital money certificate and/or some other string that is written into the digital money certificate that can uniquely identify the payee's certificate 604;

Many different formatting structures could be used to convey the necessary information required by the Payment Certification Authority System 201 to process this transaction. Before the message is sent the payer 202 signs the message with their digital money certificates that they are going to consolidate. Nesting is used to sign the message and encryption can optionally be used.

When the Payment Certification Authority System 201 receives the digitally signed message from the payer 202, it verifies the signatures and that the content of the message has not changed. If the signatures or signed content is invalid the transaction is rejected straight away. In an alternative embodiment the Payment Certification Authority System 201 will send a reject reply to the payer 202. Likewise if the formatting of the delimited text is incorrectly formatted or the optional email address included in the delimited text does not correspond to the email address that the Payment Certification Authority System 201 signed into the payee's certificate that is referenced from the unique identifier (i.e. serial number), then the transaction is rejected.

If everything checks out the Payment Certification Authority System 201 extracts the relevant payment details from the delimiting text. The Payment Certification Authority System 201 puts on hold the certificates the payer used to sign the message. While these certificates are on hold, any subsequent payments or consolidations initiated by the payer using these same certificates are rejected.

The Payment Certification Authority System 201 uses the serial number 602 included in the delimited text to reference the public key of the payee and generates a digital money certificate using the email address and public key of the payee's digital money certificate that has been referenced from the stored certificates that the Payment Certification Authority System holds. The Payment Certification Authority System 201 calculates the correct value to deem this new certificate to be worth taking into account any currency conversions and a transaction fee. The Payment Certification Authority System 201 keeps the new certificate on hold.

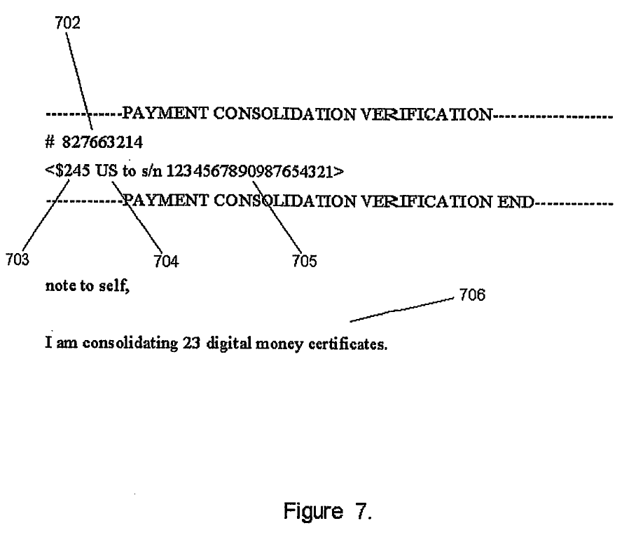

The Payment Certification Authority System 201 will take the “note to self . . . ” text 605 and adds it into a new email message to be sent to the payee's 203 email address that has been referenced. Use of the user message 605 is optional. The Payment Certification Authority System 201 can use the public key of the payee 203 to encrypt this message to the payee 203. This message will contain the newly generated consolidated certificate for the payee. The message is signed by the Payment Certification Authority System 201. The message is sent to the payee's 203 email address as referenced by the certificate that was referenced by the unique serial number. An example message is seen in FIG. 7. The message will include either in the subject or the body of the message a consolidation number/string 702 that the Payment Certification Authority uses to identify the payment/consolidation transaction. Also included are the amount 703, currency 704 and serial number of consolidation certificate 705.

When the payee 203 receives the message and verifies the authenticity of the digital signing, the digital money certificate is installed to the payee's 203 certificate store. The payee 203 sends a reply to the Payment Certification Authority System 201. The reply must contain the identifying transaction identifier either delimited in the body or included in the subject. This reply is signed with either the old payee certificate or the new payee certificate and sent back to the Payment Certification Authority System 201.

When the Payment Certification Authority System 201 receives the reply and verifies the signature and content, it references the transaction identifier and makes sure it was expecting a reply using the appropriate payee 203 certificate for signing of this reply. Once the Payment Certification Authority System 201 is satisfied with the reply it activates the new certificate that it sent to the payee. The payee 203 can then remove or backup the certificates that have been consolidated from their certificate store.

Once the payee 203 side of the transaction is concluded the Payment Certification Authority System 201 can revoke the certificates of the payer 202 that it had on hold and the transaction is considered fulfilled. No confirmation reply from the payer 202 is necessary because the payer 202 and the payee 203 are the same person.

A payer 202 can use multiple digital money certificates to make a payment. This is the same as a normal payment except that the payer 202 uses multiple digital money certificates to sign the payment message like in the consolidation case.

The Payment Certification Authority System 201 could also allow end users to renew their digital money certificates with new public/private key pairs. The user might do this for security or other reasons. A transaction fee could be charged for this renewal.

The end user might opt for a digital money certificate that only allows payments to be sent from any email address, a particular email address, or a particular domain name. Accordingly certificates could be marked as ‘transferable’, ‘nontransferable’, or ‘nontransferable domain’. Such marking would be signed into the digital money certificate and the restrictions would be enforced by the Payment Certification Authority System 201.

It is also possible for the Payment Certification Authority System 201 to define a standardised monetary type for the internet transactions called for example an Internet Credit (IC). Having a standardised monetary type would make it simpler for users of digital money as they would not have to carry out or be confused by conversion from one monetary type to another. The internet could be seen as a virtual country with it's own monetary type.

End users would also be able to split certificates into smaller amounts. Such a transaction is merely the reverse of consolidating.

In a preferred embodiment a plug-in is used with the users messaging user agent. While not necessary the plug-in makes the correct selection of certificates, managing the certificates, formatting the messages correctly, ensures signing the messages appropriately, ensures encrypting appropriately, automating replies, makes acquisition of certificates easier. The plug-in facilitates the ease at which an end user can carry out a digital money transaction. In the preferred embodiment, if a payer 202 wants to pay a payee 203, all they do is input the payee's 203 serial number into a dialog box, input the amount to be paid and click on the pay button.

Additionally digital money holders can convert the value of their digital money certificates into conventional monetary forms. To do this the digital money holders send a message to the Payment Certification Authority System 201 in the form of an email that is signed with the digital money certificate that they wish to convert. This message could be encrypted for extra security. The message conveys the “convert to” details of the purchaser, subject to the conversion options provided by the Payment Certification Authority System 201 and the expected formatting rules that the Payment Certification Authority System 201 defines. As with other digital money transactions these formatting rules can be delimited in the body of the message.

When the Payment Certification Authority System 201 receives the digitally signed conversion message from the digital money holder, the Payment Certification Authority System 201 verifies the digital money certificate that was used for signing is a valid digital money certificate. The signing certificate gets put on hold while the transaction is being processed. The Payment Certification Authority System 201 verifies that the content of the message has not changed. If the signature or signed content is invalid the transaction is rejected. Further if the formatting of the delimited text is invalid the transaction is rejected. Once all necessary checks are passed the Payment Certification Authority System 201 converts the digital money certificate into another monetary form specified by the digital money holder. The digital money certificate would be revoked in the process. A transaction fee would be deducted off the digital money certificate prior to the conversion transaction being carried out.

Multiple digital money certificates can be converted in a single conversion transaction. In this case, all of the digital money certificates that the holder wishes to convert would be used to sign the conversion message.

Although the embodiment is described with reference to email based digital messaging, any type of digital messaging that can accommodate digital certificates as used with Public Key Infrastructures can be used. An example of which would be instant messaging.

Digital money could also be stored on smart cards or any other cryptographic tokens. By storing the encryption keys and certificates on a smart card, this provides a convenient level of portability. A pin or password would be used to access the smartcard. Well designed cryptographic tokens generate encryption keys directly on the token and prohibit extraction of encrypted keys, except possibly in encrypted form. Smartcard usage is a well understood technology.

### Digital Lottery

In the preferred embodiment a company sets up a Public Key Infrastructure and associated Certification Authority Hierarchy System for the purposes of supporting an internet based lottery. Referring again to FIG. 2 the system 201 sells out lottery tickets in the form of X.509 type digital certificates that can be used with an end user email application to digitally sign and optionally encrypt email messages conformant to the PKCS#7 standard or a derivative of it such as PEM and S/MIME.

In the preferred embodiment an X.509 type digital certificate is deemed to be a lottery ticket and is used as a digital lottery certificate by embedding one or more strings within the certificate. The embedded strings are conformant to the types of strings allowed for the particular fields within the certificate. Examples of some types of strings are PrintableString, TeletexString, BMPString, UTF8String, UniversalString, IA5String. In the preferred embodiment a string is placed in the ‘subject name’ field to convey directly or indirectly the lottery numbers associated with the digital certificate. In an alternate embodiment, other fields such as extended non-critical fields could also be used to convey this information.

When users 202, 203 purchase digital lottery certificates, their selected lottery numbers or automatically generated numbers are signed into the digital lottery certificate or alternatively a string that indirectly references the lottery numbers is signed into the digital certificate. The purchasers 202, 203 email address is also signed into the certificate. Each digital lottery certificate has a unique serial number. The serial number is important because it is guaranteed to be unique as compared with all other certificates. In an alternate embodiment some other unique string that has been written into the certificate is used to uniquely identify the certificate.

The system does not have to verify the identity of the lottery certificate purchaser 202, 203 when the certificates are purchased. There is no need for the purchasers name to be written into the certificate as only the purchaser 202, 203 has access to their private key associated with a public key that is signed into the lottery certificate.

In the preferred embodiment a validity period is signed into a certificate and is representative of the start period for a particular lottery draw.

Only the system 201 has access to the complete list of certificates issued. The lottery system 201 notifies any lottery winners by email that they have won and posts the winning numbers on the internet for end users to check. The email addresses for which notifications are to be sent are extracted from the winning digital lottery certificates.

To obtain a digital lottery certificate the lottery purchaser 202, 203 generates a public/private key pair and sends the public key to the lottery system 201 to be signed into an appropriately deemed certificate. The selected lottery numbers and the email address of the lottery purchaser 202, 203 are signed into the certificate by the lottery system. The lottery company 201 sends back to the purchaser the signed digital lottery certificate. The purchaser 202, 203 can use this digital lottery certificate to send and receive payment details and notifications to the lottery system through email.

If a purchaser 202, 203 wins a prize in the lottery the lottery system 201 notifies them at the email address that is signed into the lottery certificate that has won.

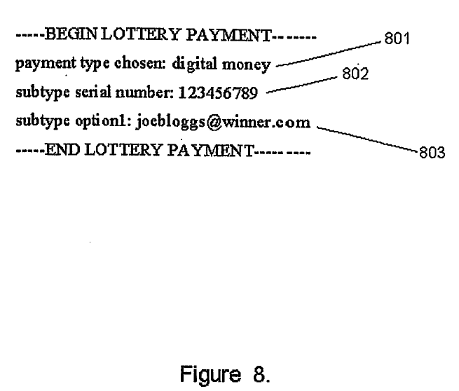

To collect their winnings the end user sends an email to the lottery system 201 in the form of a message that is signed with the lottery certificate that has won a prize. An example of the delimited text in the body of the message can be seen in FIG. 8. This message could also be encrypted for extra security. The message conveys the payment details of the purchaser, subject to the payment options provided by the lottery system and the expected formatting rules that the lottery company defines. The message would include payment type 801, in the case of payment by digital money a unique certificate serial number 802 and email address 803. These formatting rules can be delimited in the body of the message.

The use of formatting rules allows the message containing the end user payment details to be automatically processed by the lottery company.

It is envisioned that digital money could be used as a payment option as well as other conventional payment options. Winners of large amounts would be paid by conventional methods and winners of lesser amounts by digital money payments. Other payment methods are of course possible.

When the lottery system 201 receives the digitally signed message from a lottery winner 202, the lottery system 201 verifies the certificate used for signing is a valid winning certificate. The lottery system 201 verifies that the content of the message has not changed. If the signature or signed content is invalid the transaction is rejected. Further if the formatting of the delimited text is invalid the transaction is rejected. Once all necessary checks are passed the lottery system will extract the relevant payment details and pay the winner subject to those details.

The lottery system 201 revokes the certificates that have not won a prize after lottery draw. Lottery certificates that have won are only revoked after the winners payment details have been confirmed and verified or the digital certificate expires.

Although the embodiment is described with reference to email based digital messaging, any type of digital messaging that can accommodate digital certificates as used with Public Key Infrastructures can be used. An example of which would be instant messaging.

In a preferred embodiment a plug-in is used with the purchasers messaging user agent. While not essential the plug-in facilitates the selection of digital lottery certificates, managing the certificates, formatting the messages correctly, signing the messages appropriately, encrypting appropriately if necessary, and the acquisition of digital lottery certificates. The plug-in makes it easier for an end user to participate in a digital lottery.

Digital Certificate Functions

Digital certificate functions relates to the manipulation of data in a computer internetworking environment, and to retrieving, processing and interacting with embedded program objects and data objects that are referenced from fields within a digital certificate.

Digital Certificate functions provide a means to allow a user of a digital certificate aware application on a computer connected to an internetworking environment to access and execute a program object that is referenced from a digital certificate. The program object being an application program, code, or script. Once the digital certificate is parsed by a digital certificate aware application, the program object that is referenced from the digital certificate executes on the users computer or may execute on a remote computer. Once launched the user is able to interact with the program object that has been referenced. This occurs because there is ongoing interprocess communication between the program object and the digital certificate aware application.

In a broad sense the digital certificate is a vessel for instructions that are to be carried out and the means for defining how to carry out those instructions.

One application of the embedded program object is to allow a user to interact with a remote database referenced by a digital certificate that is parsed. Another application is to process and display particular fields within a digital certificate to the user in a particular format as determined by the program object and/or field or fields that are parsed. Yet another use is to process and display data objects external to the digital certificate yet are referenced from the certificate.

Data Objects may broadly be said to consist of text data, video data, sound data, image data, or other types of informational data that is able to be presented to a user of a computer system. Data Objects may be embedded in digital certificates in specified fields or may be referenced from these fields.

It will be that the digital certificate can be seen as a platform to launch applications and access data with the added benefit of the integrity of a digital signature, namely, the Certification Authority that signed the digital certificate, certifying those launch instructions.

In the preferred embodiment the digital certificate provides a means for running embedded program objects in a computer internetworking environment supportive of Public Key Infrastructure and digital certificates. The method contains the steps of providing at least one client computer and one network server joined to the internetworking environment where the internetworking environment is typically the internet; processing and displaying, on the client computer, a portion of a digital certificate received over the internetworking environment from the server computer, where the digital certificate includes an embedded reference to a controllable application, code, or script; and interactively controlling the controllable application, code, or script from the client computer via communication sent over the internetworking environment.

An alternate embodiment would involve embedding a reference to an application program, code, or script which runs only on the client computer, but which provides the user of that client computer with more functionality than exists in the digital certificate aware application alone.

The embodiment permits a user at a client computer connected to an internetworking environment to determine the location of, retrieve and manipulate objects in an interactive way. The invention not only allows the user to use a digital certificate to locate and retrieve program objects and data objects, but also allows the user to interact with an application program, code, or script located at the local or a remote computer. Interprocess communication between the digital certificate aware application and the embedded application program, code, or script is ongoing after the program object has been launched.

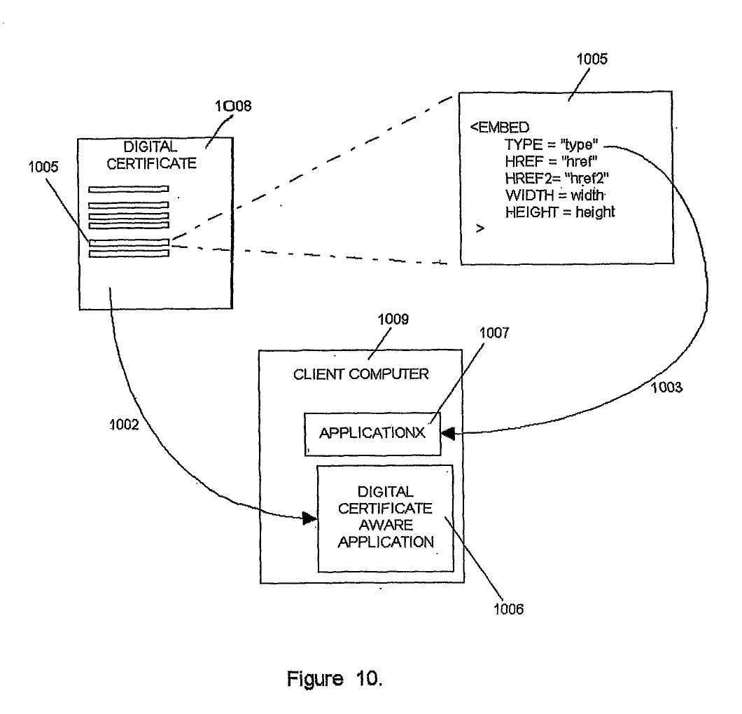

Referring to FIG. 10, once a digital certificate 1008 has been loaded by client computer 1009, a digital certificate aware application 1006 parses 1002 digital certificate 1008. In parsing digital certificate 1008, digital certificate aware application 1006 detects links to data objects located within the digital certificate and/or external to the digital certificate but referenced from the digital certificate. Digital certificate 1008 includes an embedded program link 1005 at some field within the digital certificate such as an extended non-critical field or some other field. Embedded program link 1005 identifies an applicationX 1007 as an application to invoke 1003. In the example the application, namely, applicationX 1007, resides on the same computer as the digital certificate aware application 1006 that is used to parse the digital certificate 1008. In an alternate embodiment, applicationX 1007 would reside on a remote computer. An embedded program link 1005 may include extra information, such as parameters, that tell applicationX 1007 how to proceed. This extra information would be passed to the application program, code, or script that is invoked. For example, embedded program link 1005 may include a reference to a data object or objects that applicationX 1007 is to retrieve and process. These data objects could be contained within fields of the certificate 1008 or could be referenced from fields within the certificate and/or they could be direct external links such as a URL.

When digital certificate aware application 1006 encounters the embedded program link 1005, it invokes 1003 applicationX 1007 and applicationX 1007 executes instructions to perform processing in accordance with the present embodiment. ApplicationX may optionally be invoked with parameters or other additional information.

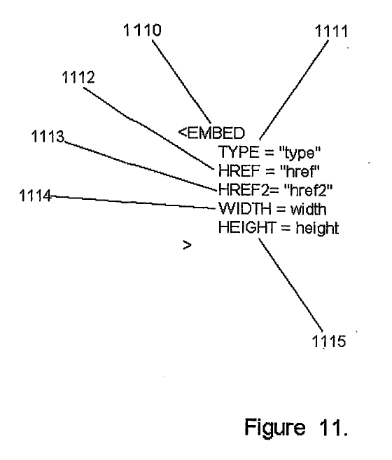

Referring to FIG. 11, an example tag format used to embed a link to an application program within a digital certificate subject to the allowable characters for a particular field of a digital certificate is shown.

The tag format can take on many different formats but it should be conformant to the string type and the types of characters that are allowable for a particular field of a digital certificate.

Referring to FIG. 11, the EMBED tag 1110 includes TYPE 1111, HREF 1112, HREF2 1113, and WIDTH 1114 and HEIGHT 1115 elements. In the preferred embodiment the TYPE element 1111 could be a Multipurpose Internet Mail Extensions (MIME) type but any other TYPE element 1111 that can directly or indirectly determine an application to invoke can be used. Some examples of values for the TYPE element 1111 are “application/dm-app” or “sound/mp3”. The type “application/dm-app” indicates that an application named “dm-app” is to be used to handle the data object at the location specified by the HREF element 1112. HREF element 1112 could specify a location/field or fields within the certificate or an external location such as a URL that specifies a source of data to be processed by the application that was invoked from TYPE element 1111. Other types are possible such as “application/notepad”, “application/mozilla” etc. In the case where TYPE 1111 is “application/appX” this means that the object at the location address specified by HREF 1112 is to be processed by the application appX. However, any manner of application program may be specified by the TYPE element 1111 so that other types of applications, code or script, such as a browser program, database program, video program, etc, may be used. Accordingly, the object referenced by the HREF element 1112 would be, respectively, an html object, a database object, and a multimedia object, etc.

It can be seen that HREF 1112 can point directly to a location external to the digital certificate or, alternatively, HREF 1112 can point to a location/field within the digital certificate and subsequently, that field may contain the data or point to a location external to the digital certificate. In the later case, HREF 1112 is indirectly pointing to an external location.

In an alternate embodiment, TYPE 1111 values such as “video/avi”, “image/bmp”, etc, describe the type of data that HREF 1112 specifies. In this case the TYPE element 1111 values, rather than specifying the absolute application to invoke, specify a relative application to invoke (relative to the type of data). This is useful where an external application program, such as an audio player, needs to know what format the data is in, or where the digital certificate aware application 1006 needs to determine which application to launch based on the data format that is presented to it. Thus, the TYPE element 1111 value can specify either an absolute application program, code, or script, or it can specify a relative application program, code, or script. Other TYPE 1111 values are possible. As noted above, HREF 1112 specifies a location of a-data object. The location address either within the digital certificate at some specified field or external to the digital certificate. For example, where TYPE 1112 is “application/mozilla” the location address HREF 1112 could be a URL address and could specify an html related object. Where TYPE is “video/mpeg” the location address HREF 1112 would typically specify a video object.

Where HREF 1112 specifies a source location for a data object, the optional HREF2 1113 specifies a destination location for the processed data to be sent. This destination location may be on the local computer system or a remote computer system such as a URL.

The WIDTH 1114 and HEIGHT 1115 elements specify the width and height dimensions, respectively, of a window to display an external application object referenced by the TYPE element 1111. In an alternate embodiment other types of dimensional display systems may be used.

In a further alternative the application program, code, or script that is invoked from the TYPE element 1111 can be digitally signed and the digital signature be checked to ensure that it chains back to a trusted Root Certificate Authority of the digital certificate that is parsed. In this way, the information within the digital certificate is processed by an application that is certified to process the information.

1. A system for transferring value including the steps of:
means for issuing a digital money certificate to a transferor, said digital money certificate including a unique identifier and an equivalent monetary value or a reference to, or an identifier of said monetary value;
means for receiving instructions from said transferor for a transfer of a specified value to a transferee, said instructions digitally signed by said certificate; and
means for transferring said value according to said instructions from said transferor to said transferee.

2. A system as claimed in claim 1 wherein said means for issuing said digital money includes:
means for receiving the public key of the transferor, means for generating said digital money certificate using said public key; and
means for sending said certificate to said transferor.

3. A system as claimed in claim 2 wherein means for issuing said digital money further includes means for placing said generated certificate on hold until confirmation of receipt of said certificate is received.

4. A system as claimed in claim 3 further comprising means for controlling access to said digital money certificates that have been issued.

5. A system as claimed in claim 4 wherein said means for issuing said digital money includes means for storing said public key of said client.

6. A system as claimed in claim 5 wherein said means for transferring value includes:
means for receiving the unique identifier of a receiving certificate to transfer said value to and being signed by at least one paying certificate, from which said value is transferred;
means for validating said paying certificate;
means for validating said instructions;
means for reducing the monetary amount of said at least one paying certificate by said specific value or revoking said at least one paying certificate and providing a replacement of equivalent monetary amount less said specific value; and
means for increasing the monetary amount of said receiving certificate by said specific value, for providing a further certificate of monetary amount equivalent to said specific value or revoking said receiving certificate and providing a replacement of equivalent monetary value plus said specific amount.

7. A system as claimed in claim 6 wherein said means for transferring value further includes:
means for sending said replacement certificates to transferor and transferee; and
means for receiving confirmation of receipt of said changed certificates

8. A system as claimed in claim 7 wherein said digital certificate is an X.509 format certificate.

9. A system as claimed in claim 8 wherein said digital certificate includes an electronic address of the owner of said certificate and said electronic address is stored with said information about said certificate.

10. A system as claimed in claim 9 further comprises means for consolidating the monetary value of multiple digital certificates into a single certificate.

11. A system as claimed in claim 10 further comprises means for converting digital money into other monetary forms.

12. A system as claimed in claim 11 wherein said means for converting digital money certificates into other monetary forms includes:
means for receiving conversion instructions signed by said digital money certificates,
means for validating said digital money certificate to be converted, and
means for validating said conversion instructions.

13. A system as claimed in claim 12 further comprises means for splitting the monetary value of a single digital certificate into multiple certificates.

14. A system as claimed in claim 13 wherein said receiving certificate is not usable as a paying certificate.

15. A system as claimed in claim 14 wherein said receiving certificate is usable as a paying certificate.

16. A system as claimed in claim 15 wherein said instructions are received by email.

17. A system as claimed in claim 16 wherein said means for validating said instructions include checking the validity of said at least one signing certificate.

18. A system as claimed in claim 17 wherein means for validating said instructions further includes validating the sender electronic address of said instructions and said certificate has at least one valid instructing electronic address included in said certificate and said at least one valid instructing electronic address is stored with said information about said certificate.

19. A system as claimed in claim 18 wherein said electronic addresses are email addresses.

20. A system as claimed in claim 19 wherein said means for validating said instructions further includes validating the sender email address domain of said instructions and said certificate has at least one valid instructing email address domain included in said certificate and said at least one valid instructing email address domain is stored with said information about said certificate.

21. A system as claimed in claim 20 wherein each said at least one paying certificate is placed on hold during said transfer.

22. A system as claimed in claim 21 wherein said digital monetary certificate includes the currency of said monetary value, said currency being stored with said information on said certificate.

23. A system as claimed in claim 22 wherein said instructions include the currency of said transfer and said system of digital money includes means for converting one currency to another.

24. A system as claimed in claim 23 wherein said instructions are generated by an email client plug-in.

25. A system for transferring value including the steps of:
means for receiving from a vendor website digital payment control in relation to offered goods and services or other valuable consideration, wherein said vendor makes said payment control available on their website for a user to activate in relation to a proposed transaction;
central authority means for storing information in association with an activated control, said information including information on said vendor and details of the transaction; and
means for providing a transaction identifier and a reverse billing method to said user.

26. A system as claimed in claim 25 wherein said means for providing a reverse billing method includes:
means for providing a number for reverse billing, said number depending on the amount of payment.

27. A system as claimed in claim 26 wherein said billing number comprises multiple reverse sms, ems or mms billing numbers.

28. A system as claimed in claim 27 wherein all of said multiple sms, ems or mms billing numbers are displayed to said user.

29. A system as claimed in claim 27 wherein only the first of said multiple reverse sms, ems or mms billing numbers are displayed to said user and on receipt of confirmation of reverse billing using said first sms billing number an sms message is sent to said user to reply to, on receipt of confirmation of reverse billing in respect of said reply to message further messages for reply to are sent until total payment has been confirmed.

30. A system as claimed in claim 27 further comprising means for obtaining payment of said amount of payment includes means for setting the amount reverse billed.

31. A system as claimed in claim 30 wherein means for setting the amount comprises notifying the sms, ems or mms reverse billing system of the amount to bill.

32. A system as claimed in claim 30 wherein means for setting the amount comprises including the amount to be billed in sms, ems or mms message sent by said user.

33. A system as claimed in claim 30 further comprising means for receiving a control includes means for receiving instructions for payment using a system for transferring value according to claim 1 and means to enable payment and/or reimbursement to be made using said digital money certificates.

34. A system as claimed in claim 33 wherein said means for receiving instructions includes means for receiving said digital money certificate serial number and an electronic address.

35. A system as claimed in claim 34 wherein said systems includes:
means for recording said transaction in association with said vendor;
means for allowing a payee to express their satisfaction or otherwise with regard to said transaction; and
means to obtain a summary of the satisfaction or otherwise of purchasers from a vendor.

36. A system of preventing unsolicited emails signed by digital certificates identifying a message sender including:
means for storing information on a plurality of said identification certificates, said information including the validity of said identification certificate;
means for invalidating the identification certificate of spam message senders.
means for sending a message to at least one recipient, signed with one of said identification certificate, and
means for checking if said message is signed by a valid certificate, wherein if said message is not signed by a valid certificate it is considered to be spam; and

37. A system as claimed in claim 36 further comprising means for receiving a list of invalid certificates.

38. A system as claimed in claim 37 wherein said list of invalid certificates is Updated before checking if said message is signed by a valid certificate.

39. A system as claimed in claim 38 further comprising means for providing an identification certificate to a message sender.

40. A system as claimed in claim 39 further comprising means for automatically marking messages that do not have a valid digital signature as potential spam, and
means for sorting marked messages into a spam folder.

41. A system as claimed in claim 40 further comprising means for invalidating the identification certificate of a message sender who sends spam including:
means for a recipient of a signed message the recipient considers to be spam to notify the provider of said identification certificate, said spam notification including a nested copy of the signed message that is signed by the recipient;
means for the provider of said identification certificate to store said spam notification in association with said certificate; and
means for marking as invalid said certificate when the number of spam notifications by individual message recipients exceeds a certain number.

42. A system as claimed in claim 41 wherein access to said means for providing an identification certificate to a message sender is restricted.

43. A system as claimed in claim 42 wherein said means for restricting is selected from a group consisting of requiring a payment, limiting access based on IP address, limiting access based on time of last access and any other means that could be used to prevent a message sender obtaining identification certificates.

44. A system as claimed in claim 43 wherein said identification certificate includes an indication of the number of times the signed message can be forwarded on by the message recipient

45. A system as claimed in claim 44 wherein said identification certificate includes means for the sender to indicate for each signed message the number of times the signed message can be forwarded on by the message recipient.

46. A system as claimed in claim 45 wherein said means for said sender to sign at least one message with said identification certificate before sending said message to at least one recipient is a plug-in for an email client.

47. A system as claimed in claim 46 wherein said means for checking said message is signed by a valid certificate is a plug-in for an email client.

48. A system as claimed in claim 47 wherein said means for automatically marking messages that do not have a valid digital signature as potential spam is a plug-in for an email client

49. A system as claimed in claim 48 wherein said means for sorting marked messages into a span folder is a plug-in for an email client.

50. A system as claimed in claim 49 wherein said means for a recipient of a signed message the recipient considers to be spam is to notify the provider of said identification certificate, said spam notification including a nested copy of the signed message that is signed by the recipient is a plug-in for an email client.

51. A system as claimed in claim 50 wherein said list of invalid certificates is updated before checking if said message is signed by a valid certificate by a plug-in for an email client.

52. A system for running a digital lottery including:
means for issuing a digital lottery certificate, said digital lottery certificate including a unique identifier and at least one lottery entry; and
means for storing information about a said certificate and including the lottery entry details, a reference to, or an identifier of said entry details.

53. A system as claimed in claim 52 wherein said means for issuing said digital lottery certificates includes:
means for receiving the public key of a purchaser;
means for receiving the lottery numbers of said purchaser;
means for generating said digital lottery certificate using said public key and said lottery numbers; and
means for sending said certificate to said client,
means for associating said digital lottery certificate with a particular lottery draw.

54. A system as claimed in claim 53 wherein said system for running a digital lottery includes:
means for determining which lottery certificate has won a prize; and
means for notifying said winning lottery certificate owner of a win.

55. A system as claimed in claim 54 wherein said notification is conducted through email.

56. A system as claimed in claim 55 further comprising means for receiving instructions to transfer lottery winner payment details of a winning lottery certificate include:
means for validating a winning lottery certificate;
means for validating said winning lottery certificate payment instructions;
means for paying winnings.

57. A system as claimed in claim 56 wherein said payment winnings are sent using digital money certificates according to the system for transferring value as claimed in claim 1.

58. A system as claimed in claim 57 wherein said instructions are received by email.

59. A system as claimed in claim 58 wherein said means for validating said winning lottery certificate payment instructions include means for checking the validity of said signing certificate and checking the validity of signed instructions.

60. A system as claimed in claim 59 wherein said digital lottery certificate is an X.509 type certificate.

61. A system as claimed in claim 60 wherein said digital lottery certificate includes an electronic address of the owner of said certificate and said electronic address is stored in association with said information about said certificate.

62. A system as claimed in claim 61 wherein said electronic address is an email address.
